(19) United States
(12) Patent Application Publication
(10) Pub. No.: US 2007/0134281 A1
(43) Pub. Date: Jun. 14, 2007

(54) Investigate the potential of using beetle odours to deter slugs in vining peas

(76) Inventor: Nargis Abdul Gani, Cardiff (GB)

Correspondence Address: LADAS & PARRY LLP, 224 SOUTH MICHIGAN AVENUE, SUITE 1600, CHICAGO, IL, 60604, US

(21) Appl. No.: 10/581,954

(22) PCT Filed: Jan. 6, 2005
(86) PCT No.: PCT/GB05/00018

§ 371 Date: Jun. 7, 2006

(30) Foreign Application Priority Data
Jan. 14, 2004 (GB) 0400744.9

(51) Int. Cl. A01N 25/00; A01N 37/00

(52) U.S. Cl. 424/405; 514/557

(57) ABSTRACT

In the UK slugs can be a major problem in vining peas. Their climbing and feeding habit on pea plants can often result in large numbers being picked up by the viners, causing contamination and possible rejection of the crop, consequently leaving the growers to meet the loss and face the costs. A likely answer, using the current interest in natural enemies as sources of potential chemical repellents, is now being studied by a PhD student at Cardiff University and hopefully this could lead to a new slug deterrent. It has been known for quite some time that slugs are reluctant to enter areas recently colonised by ground beetles, but it is only from an extensive series of laboratory experiments that it has now become clear that slugs respond to chemical secretions from the beetles pygidial glands—situated at the tip of the abdomen (see description FIG. 1). Normally discharged from the glands in response to attack by beetle predators, these secretions contain a cocktail of noxious substances—usually a mixture of acids and alkanes although the balance may vary from species to species (see description). That this defense mechanism also works to the beetles disadvantage in alerting its own potential prey was shown recently only to cardiff university (see description, FIGS. 2-5) as a significant change in the behaviour of the slugs when exposed to beetle extracts. Video recordings used to carry out these tests revealed a direct and rapid reaction on the part of the slugs when coming into contact with beetle extracts showing that the results are very encouraging (see description, page 1). The test also revealed that these slugs do not die during the course of this experiment. This must show that when slugs are exposed to beetle extracts there will be no side effects. The important chemicals have since been obtained, from commercial sources and tested to show its effect on deterring slugs from feeding on to growing plants and its effect on deterring slugs from climbing on to growing plants, under semi-field conditions. The findings conclude that beetle odours have the potential to develop into a new slug deterrent. Chemical companies will also receive the new slug deterrent as a potential source to stop and prevent slugs from entering into other crops currently for use in the UK.

### 1. INTRODUCTION

In the UK slugs can be a major problem in vining peas. Their climbing and feeding habit on pea plants can often result in large numbers being picked up by the viners, causing contamination and possible rejection of the crop, consequently leaving the growers to meet the loss and face the costs.

A likely answer, using the current interest in natural enemies as sources of potential chemical repellents, is now being studied by a PhD student at Cardiff University and hopefully this could lead to a new slug deterrent.

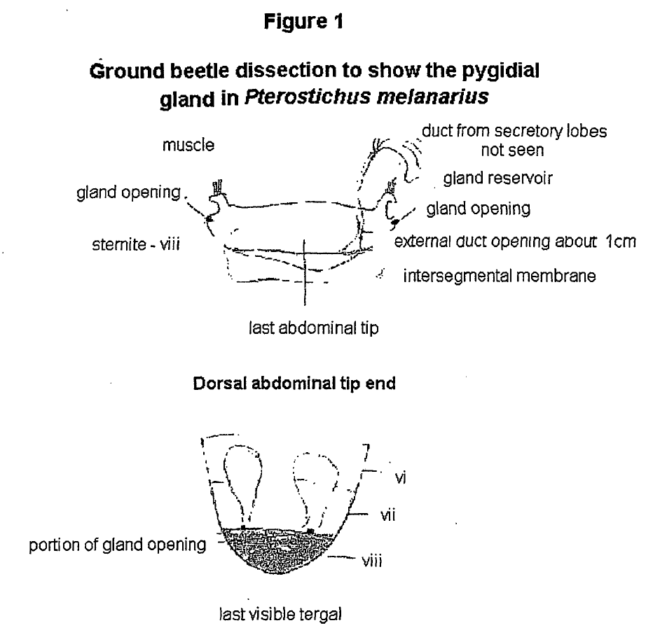

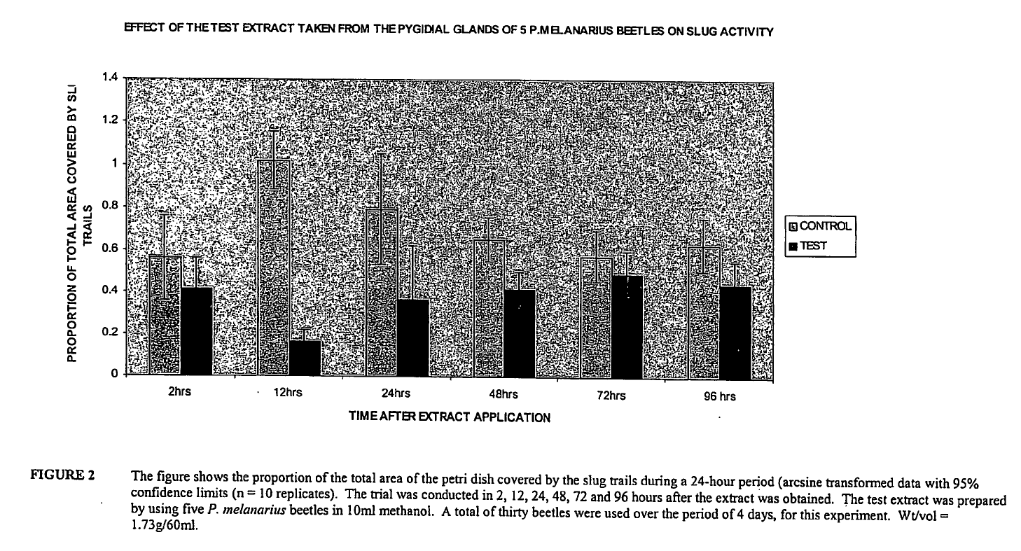

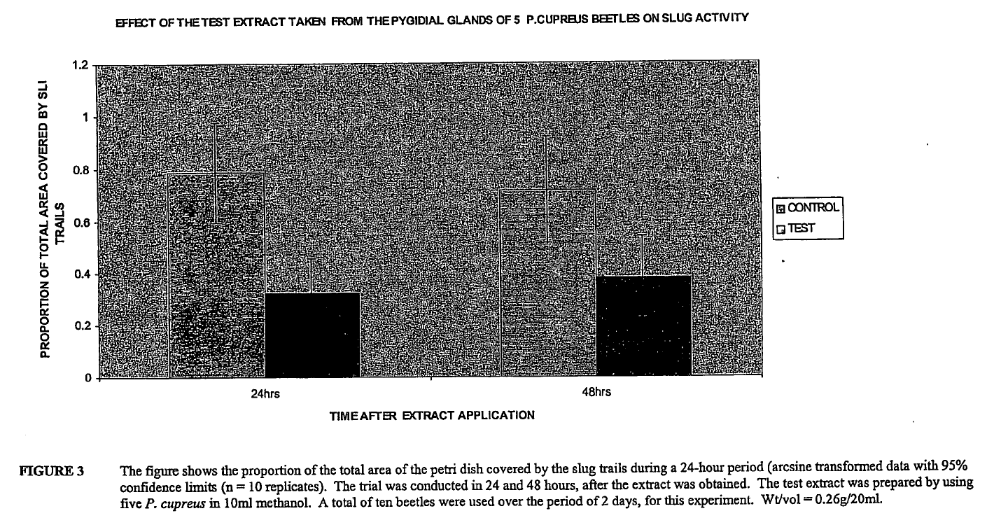

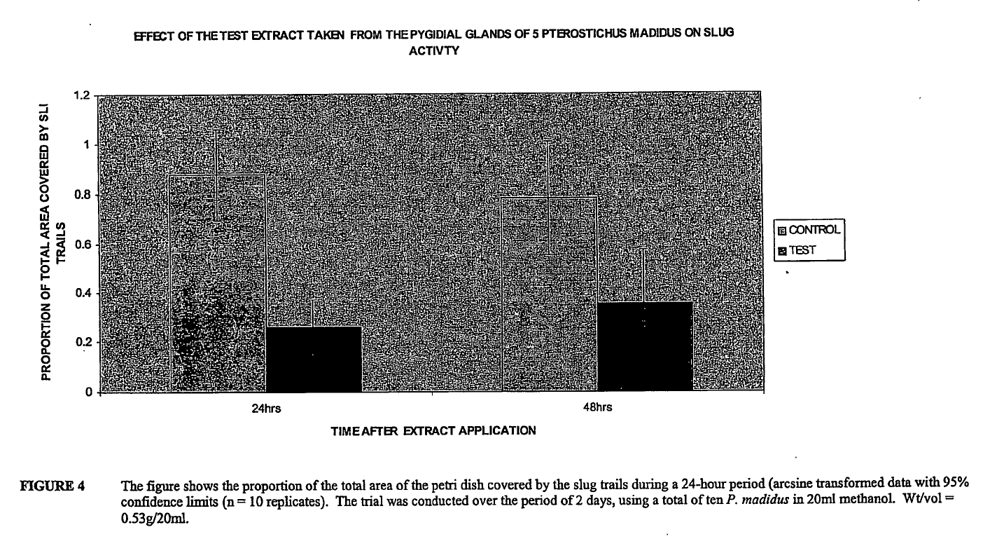

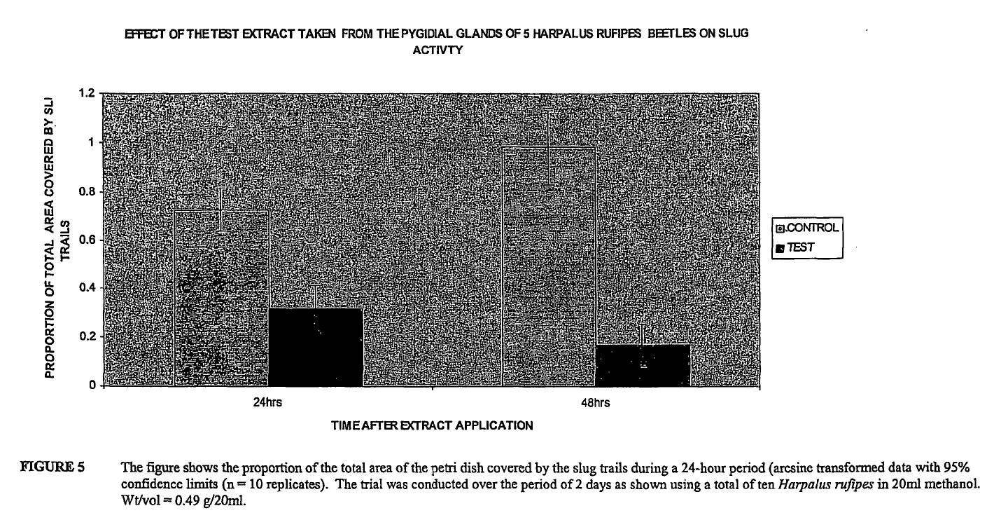

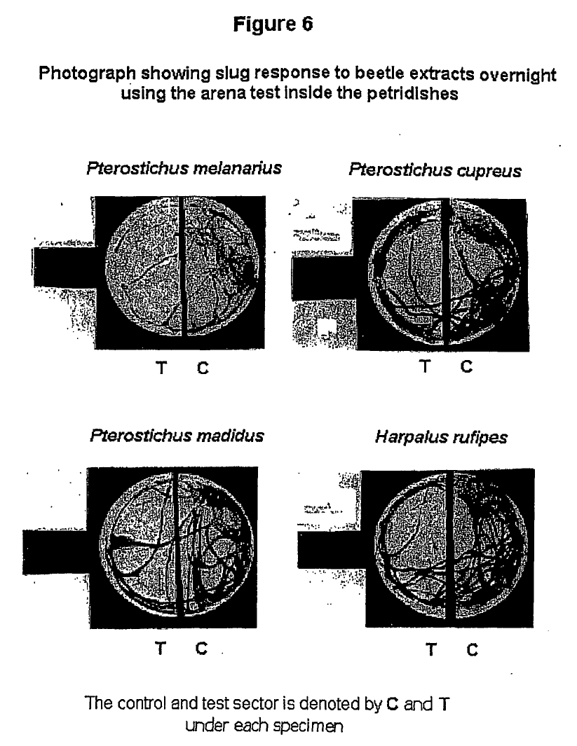

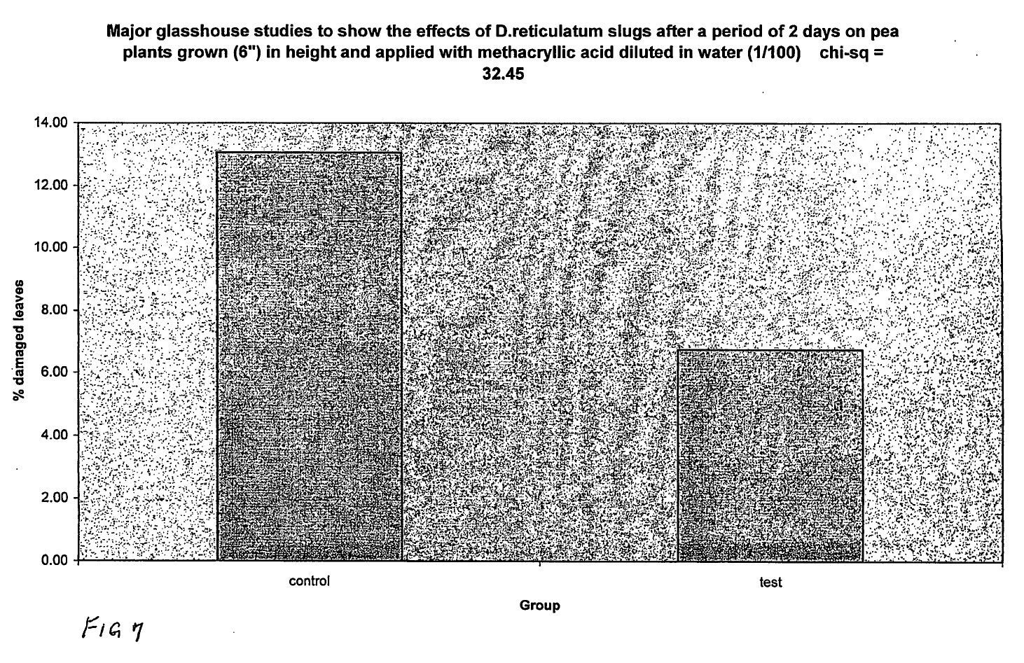

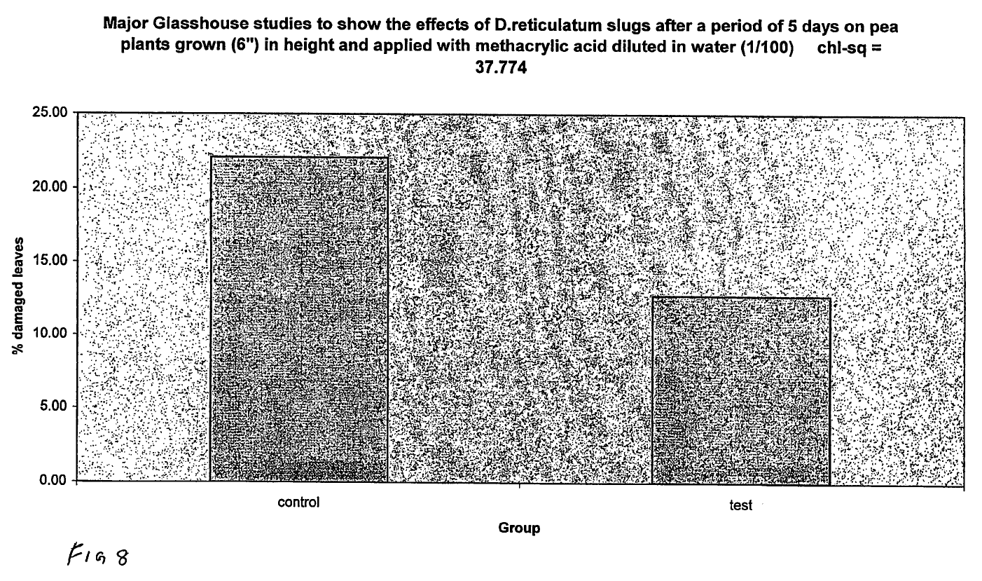

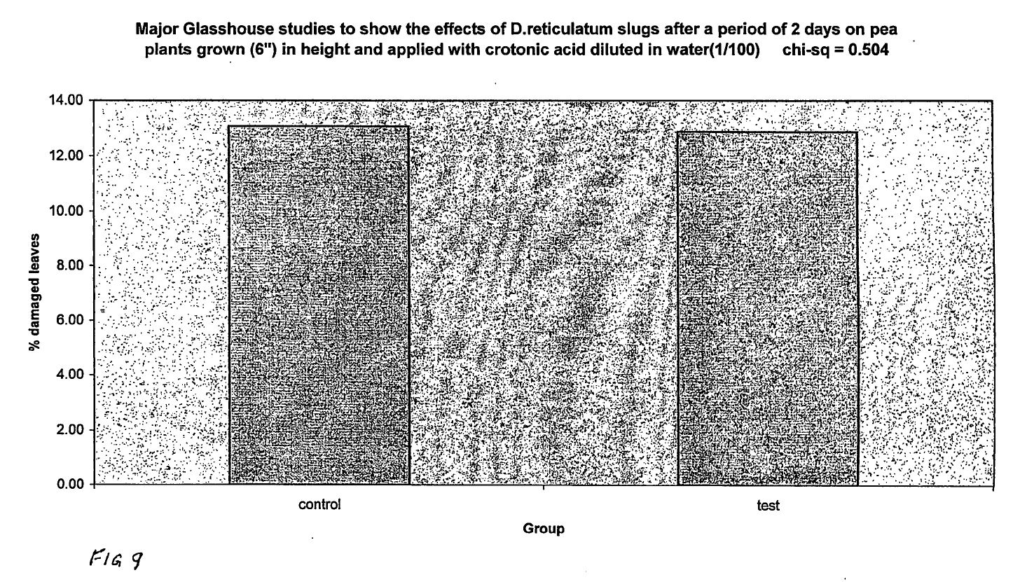

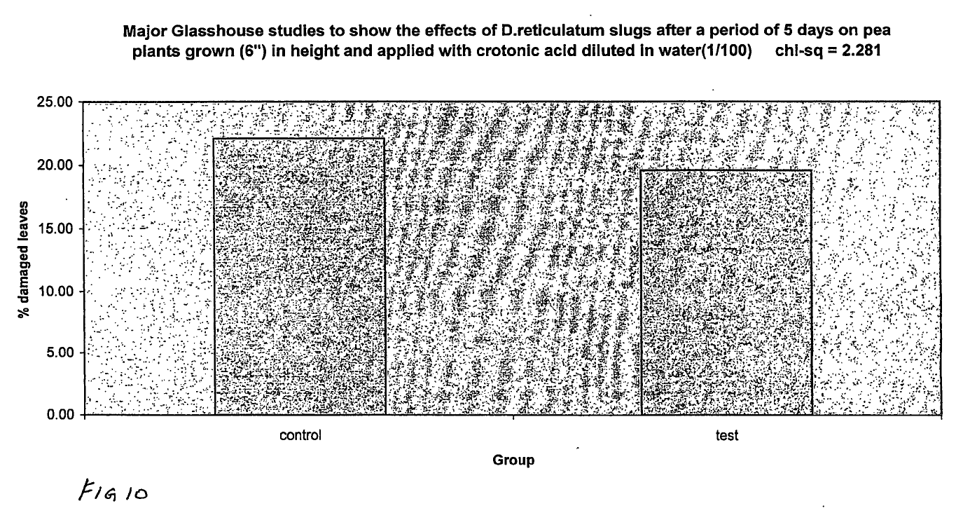

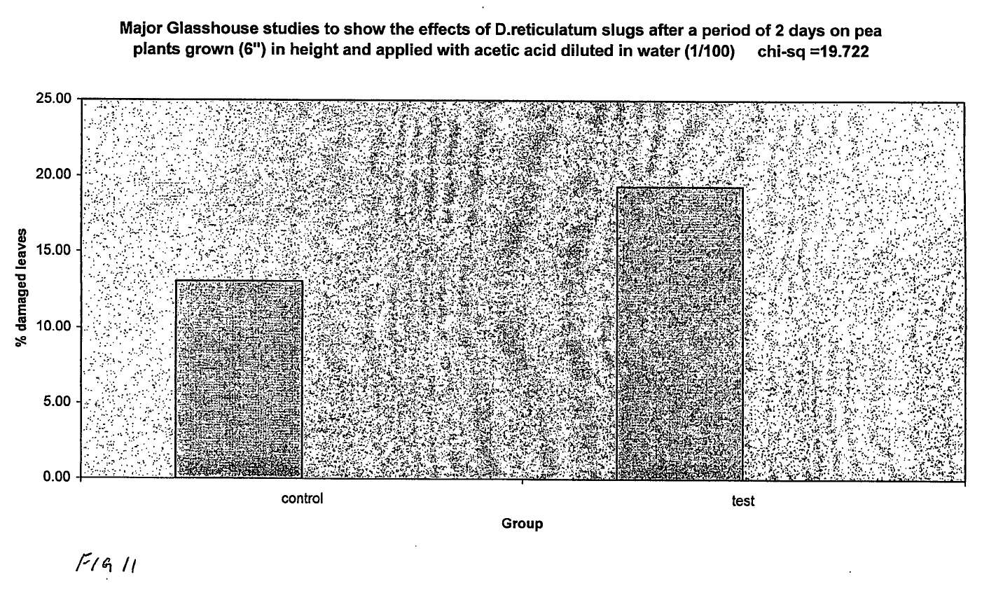

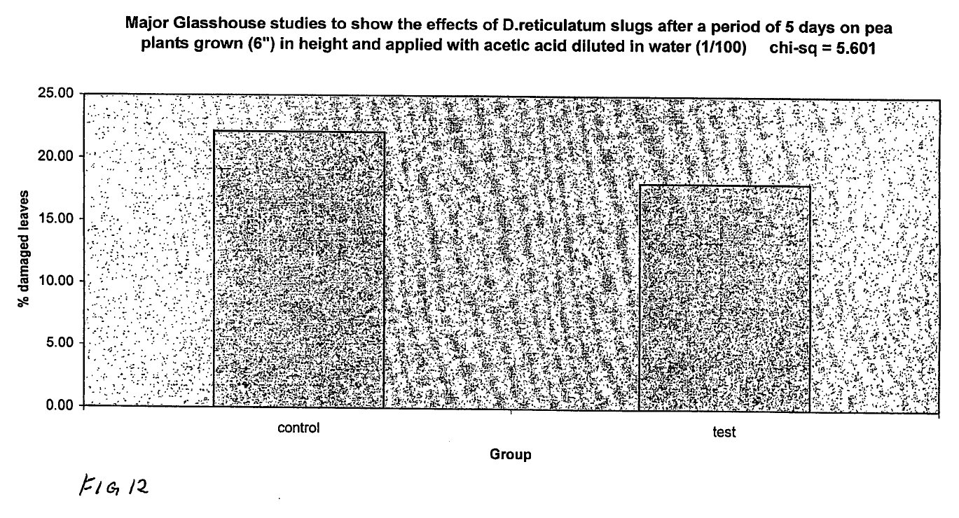

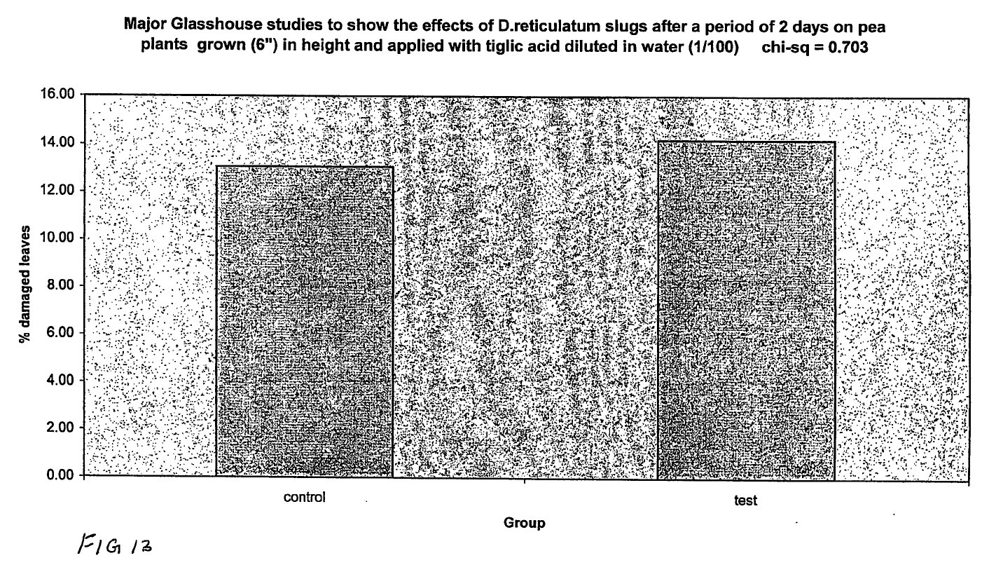

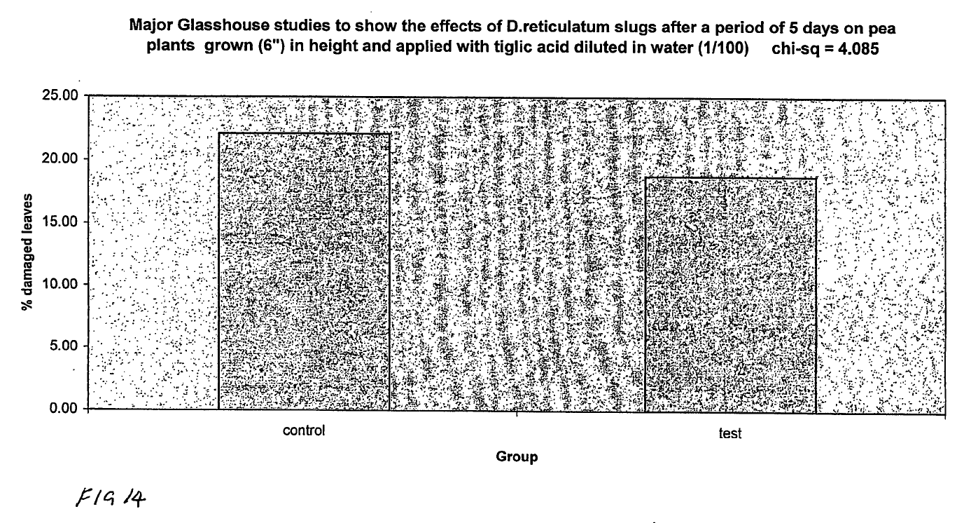

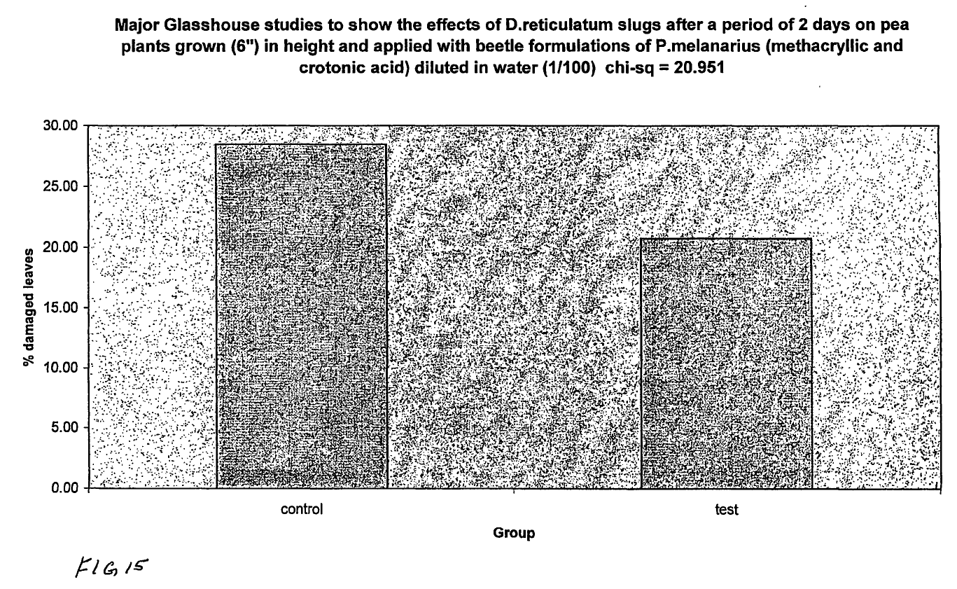

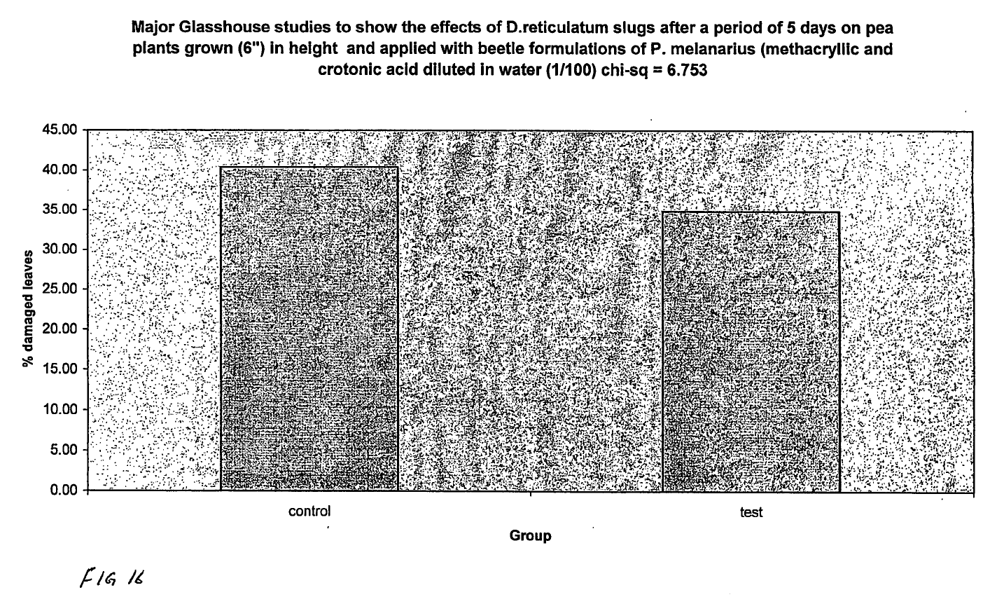

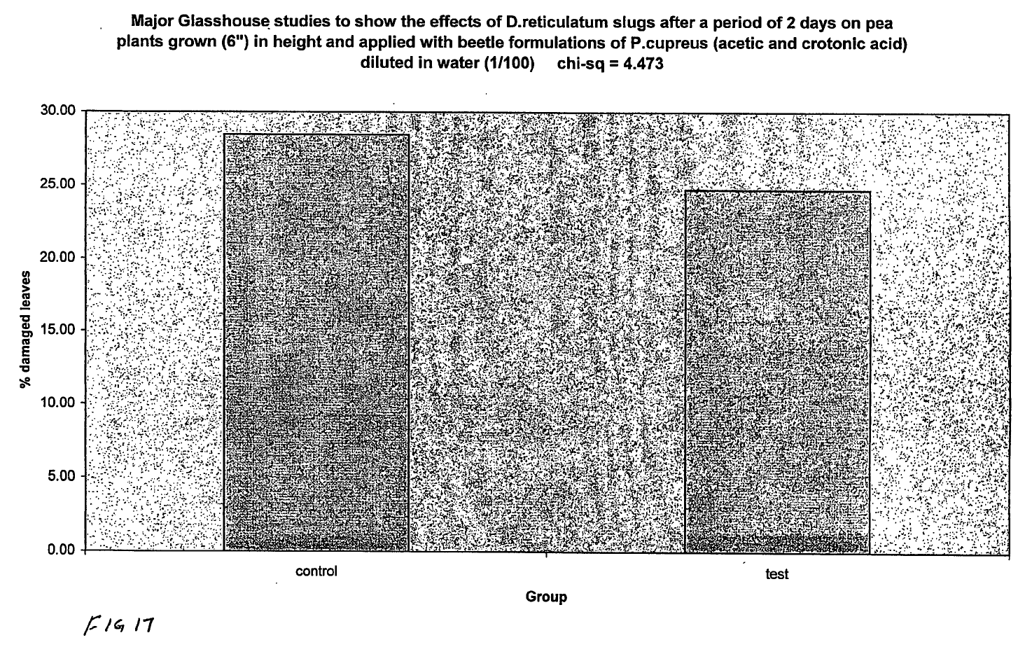

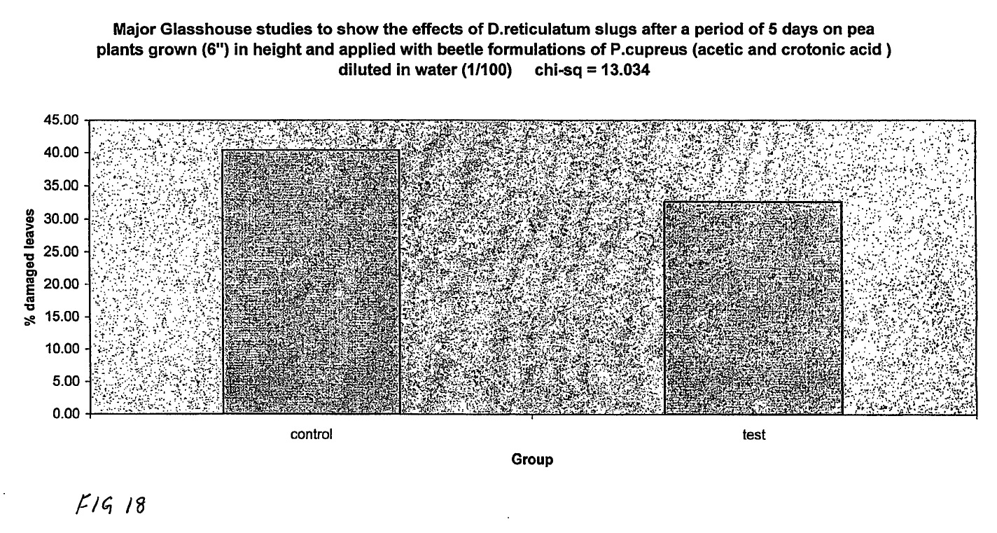

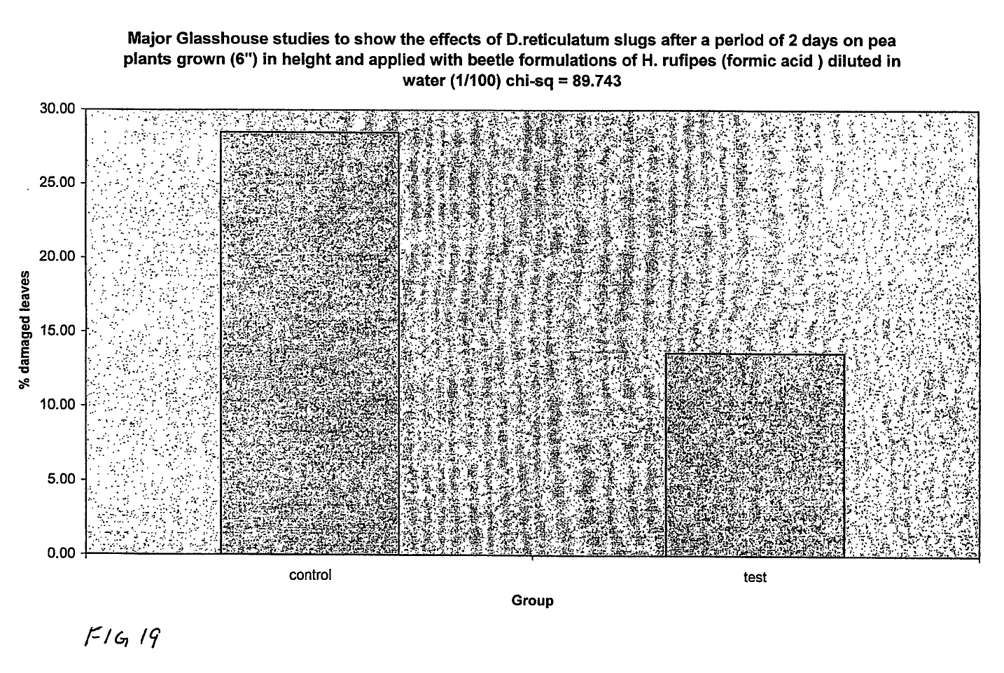

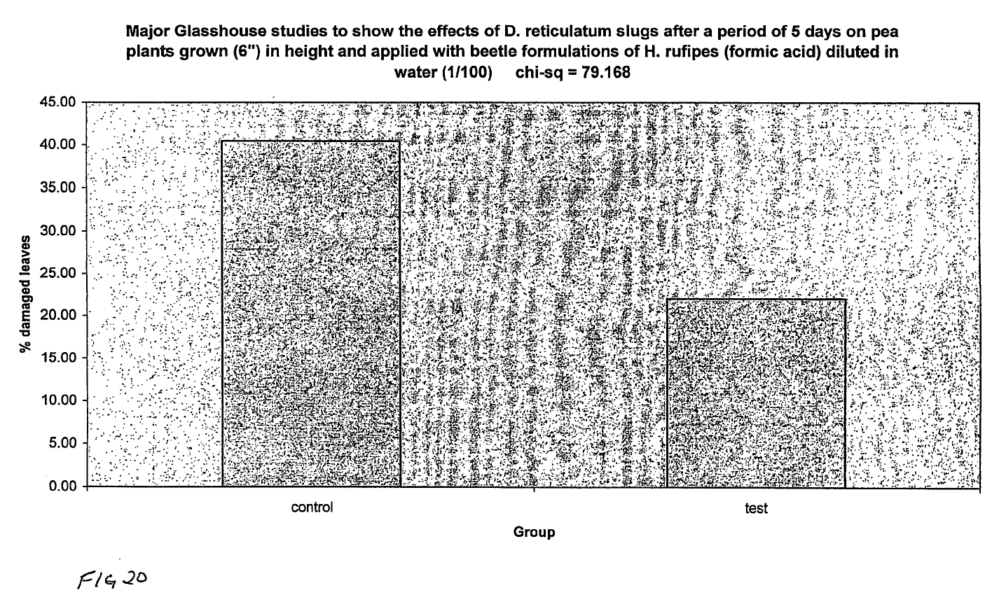

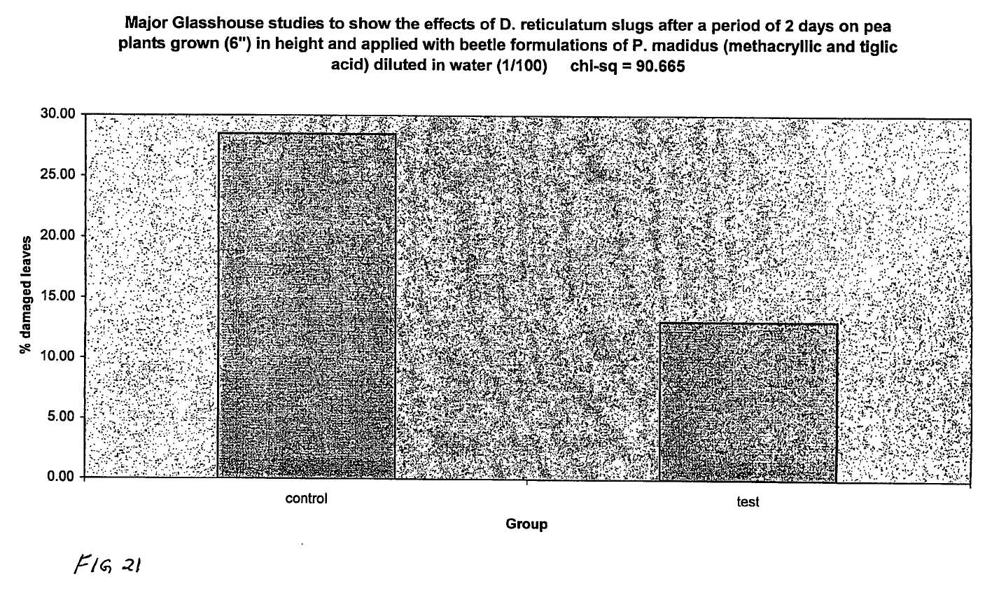

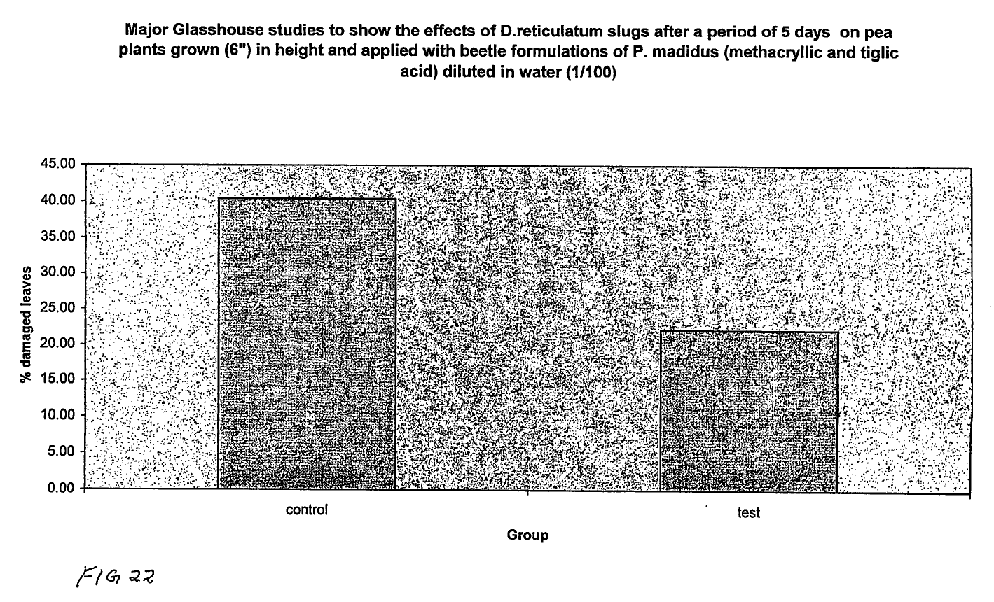

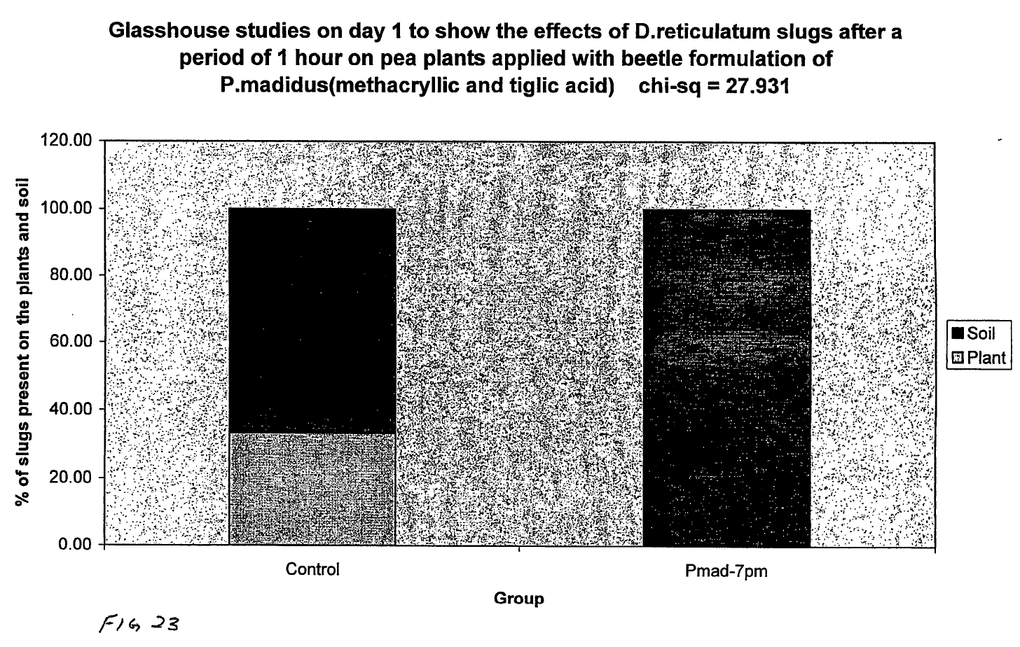

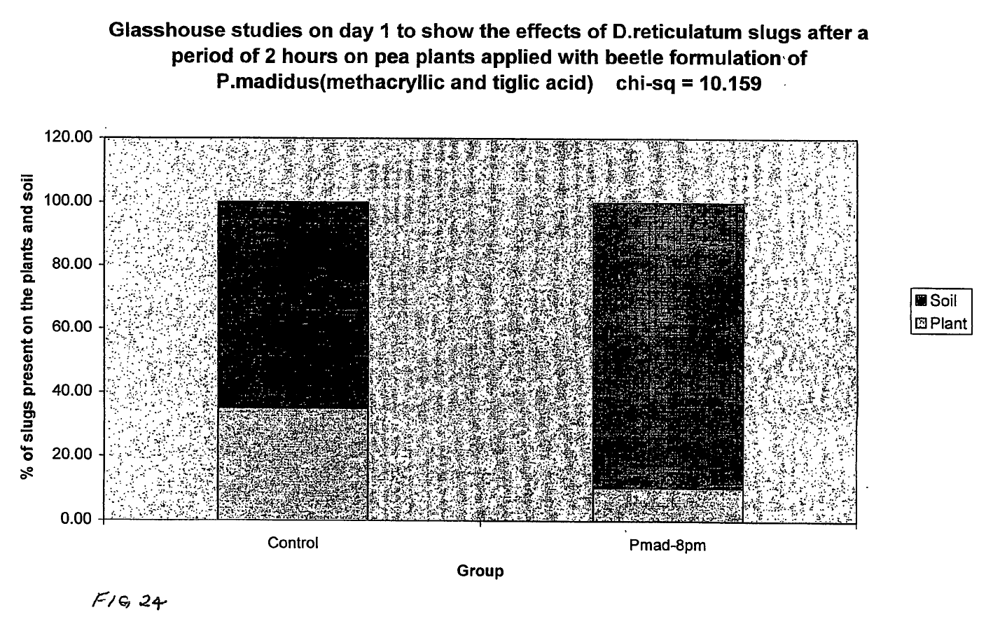

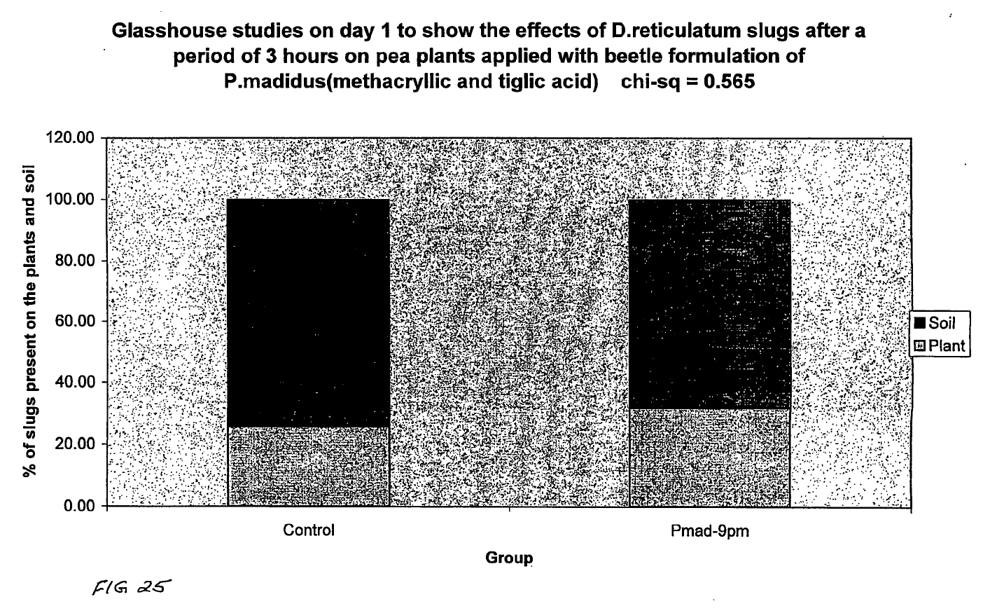

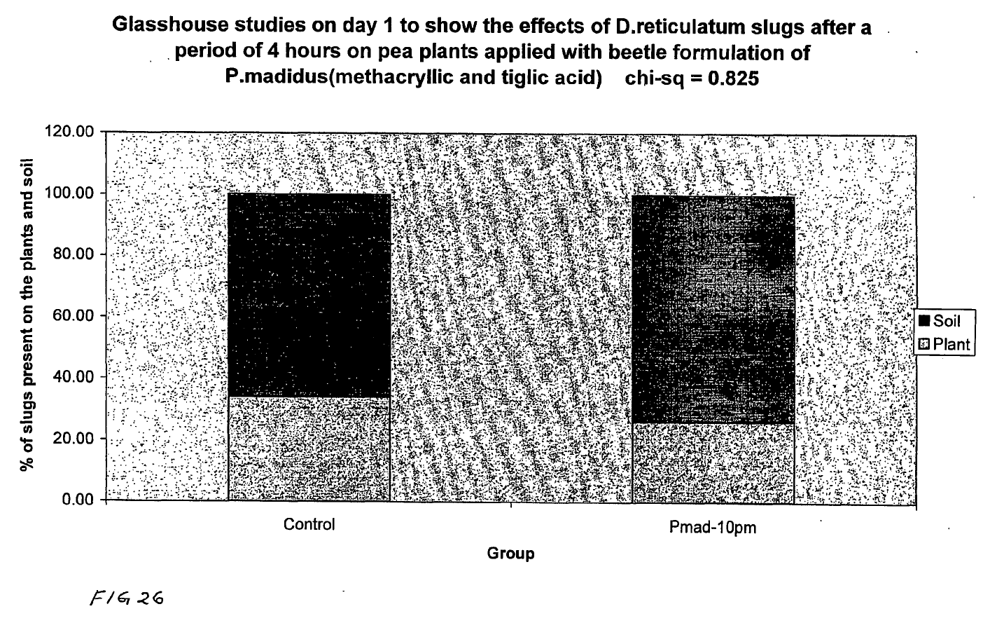

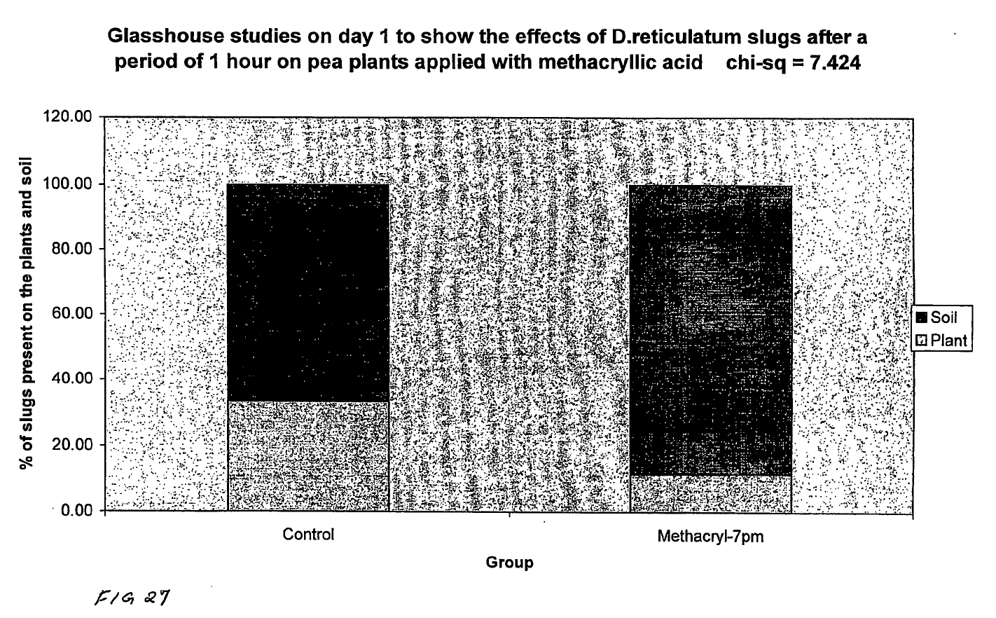

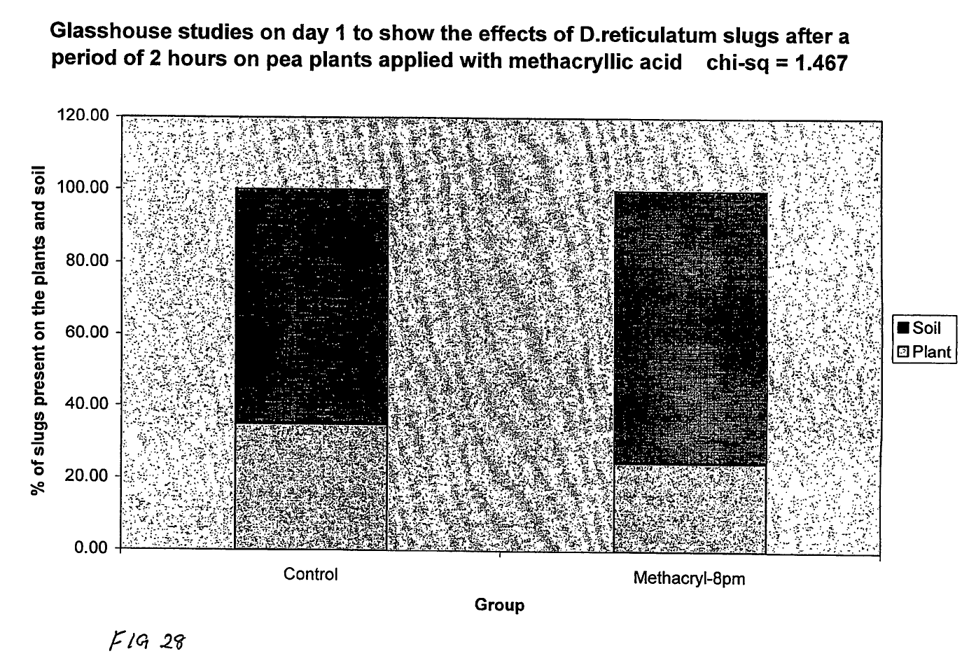

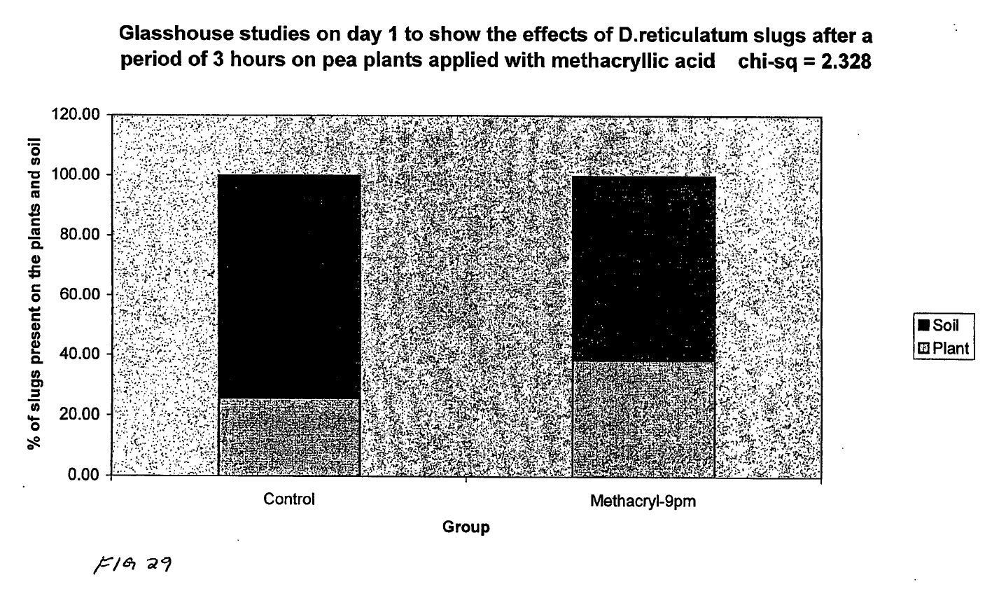

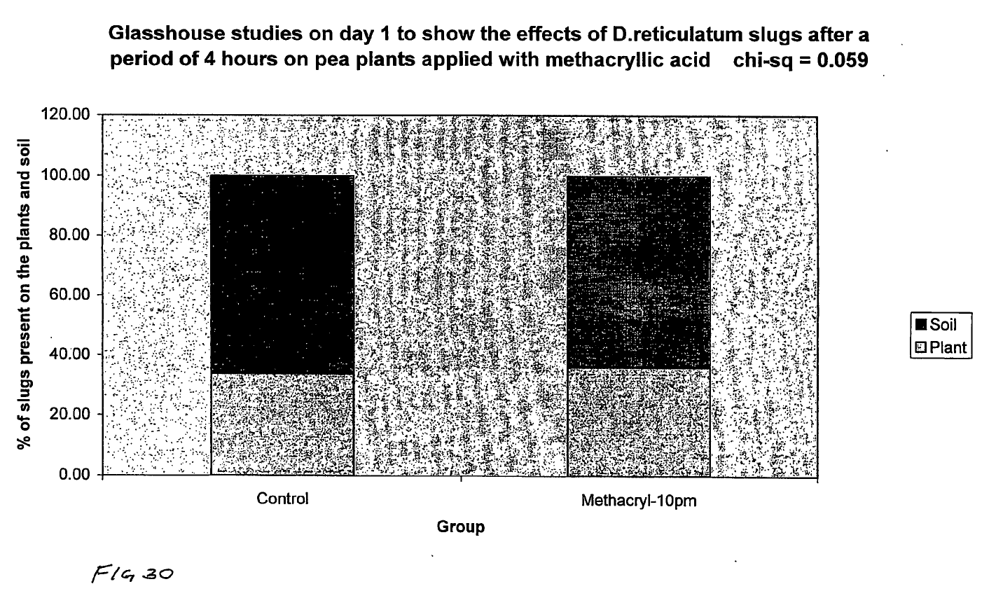

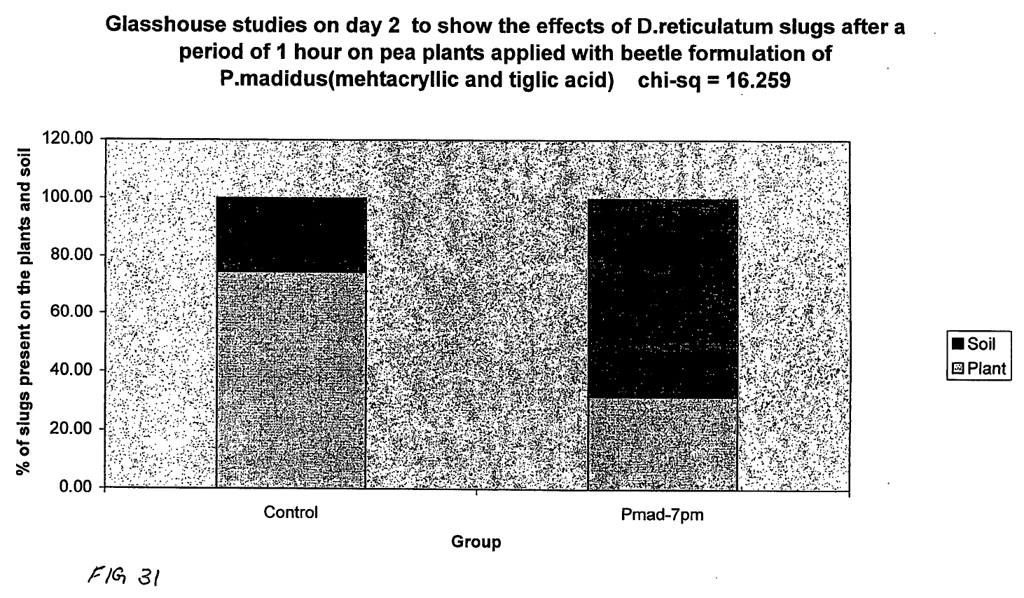

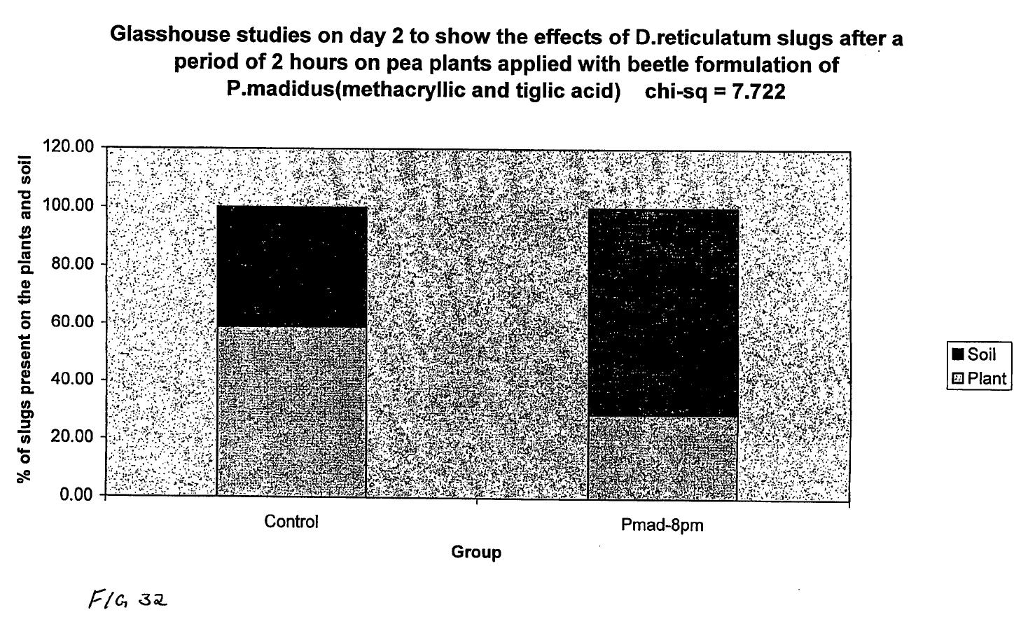

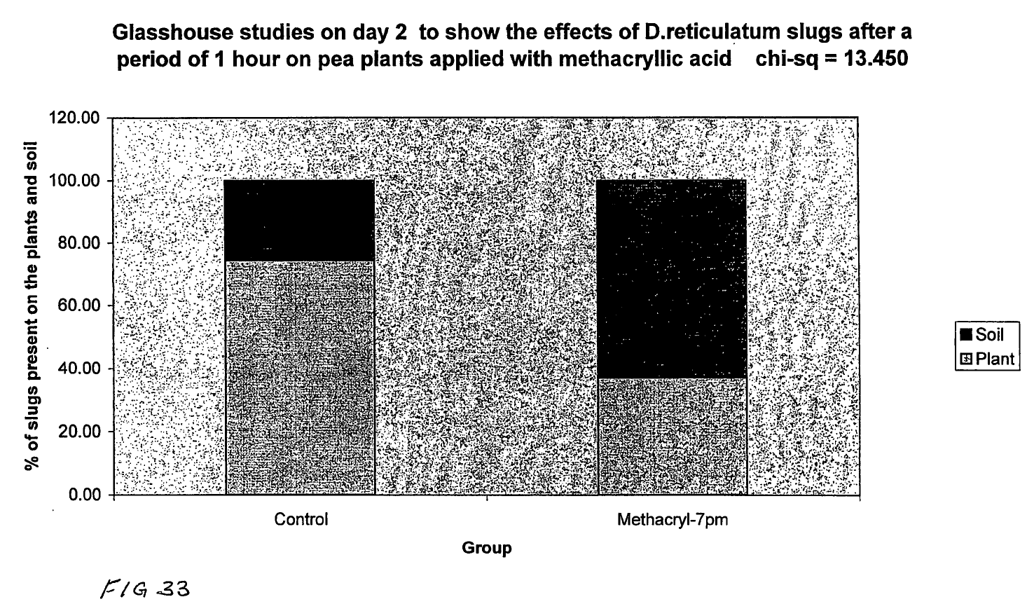

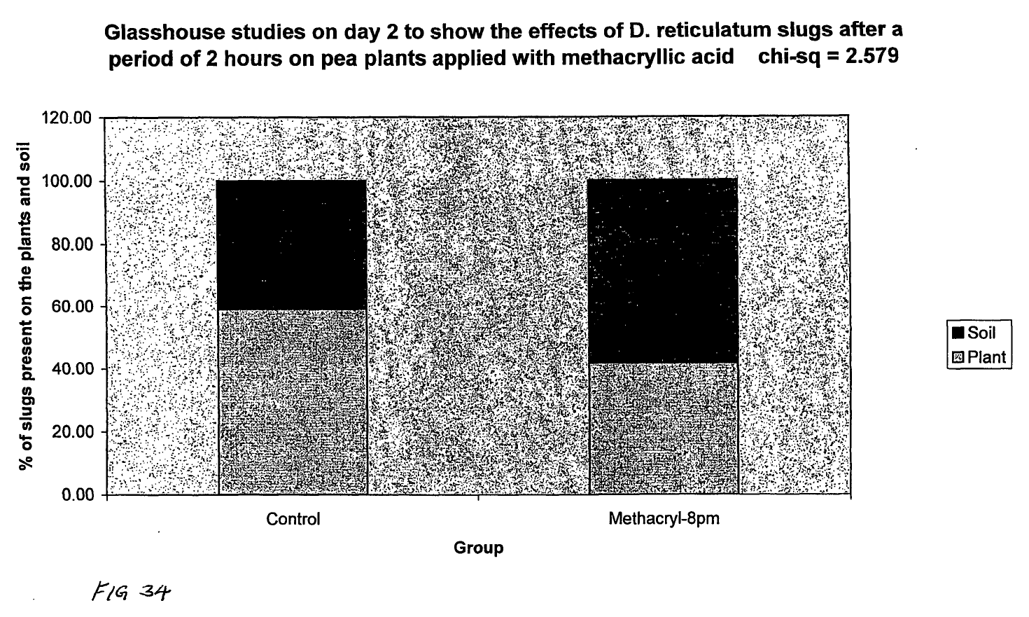

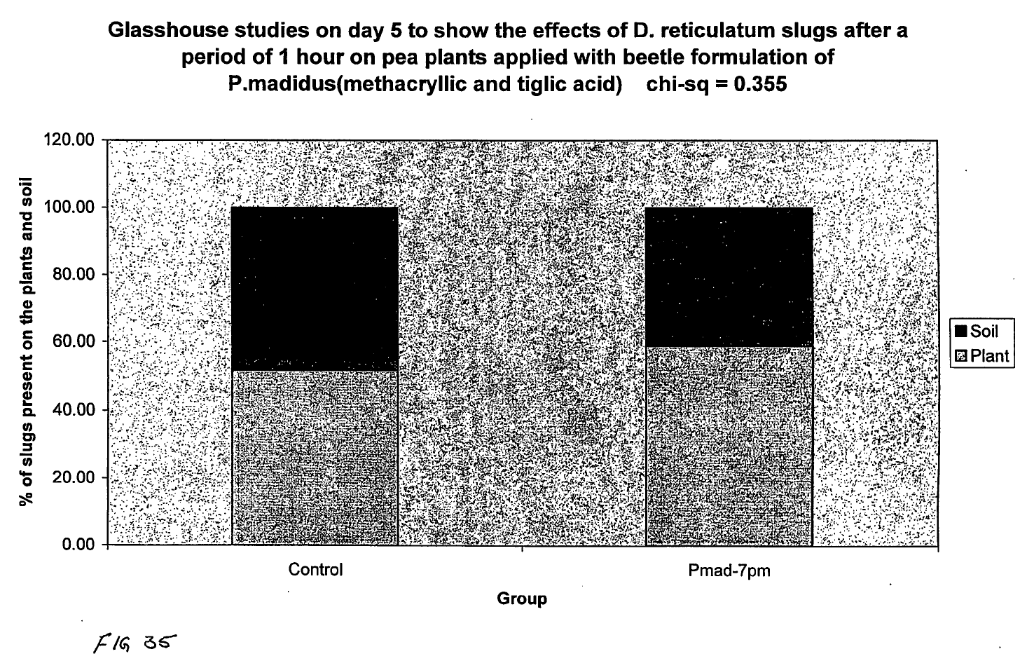

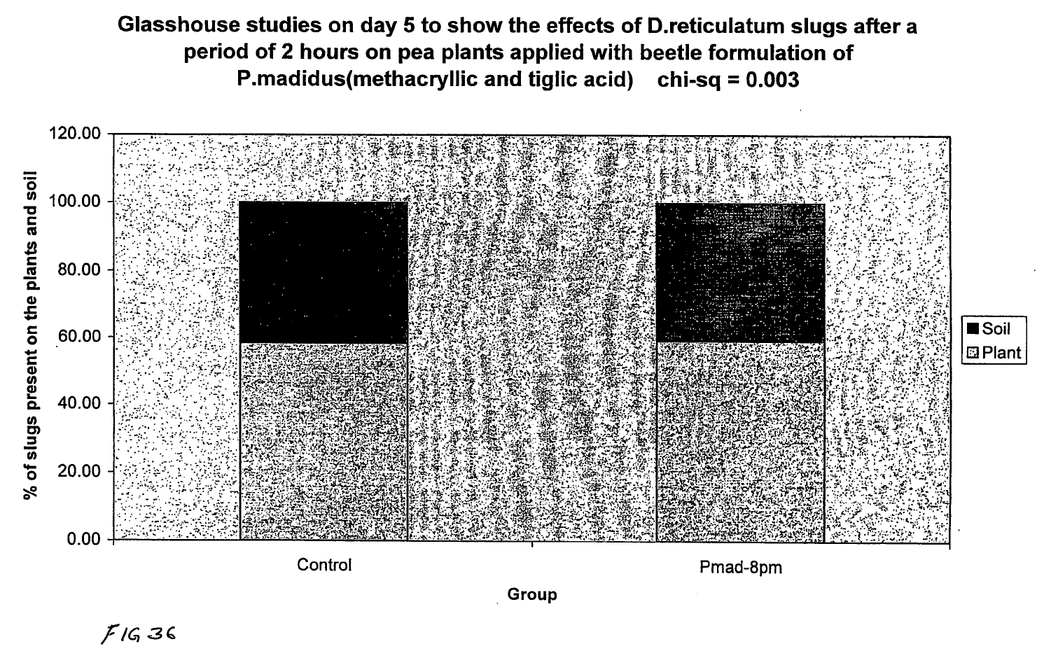

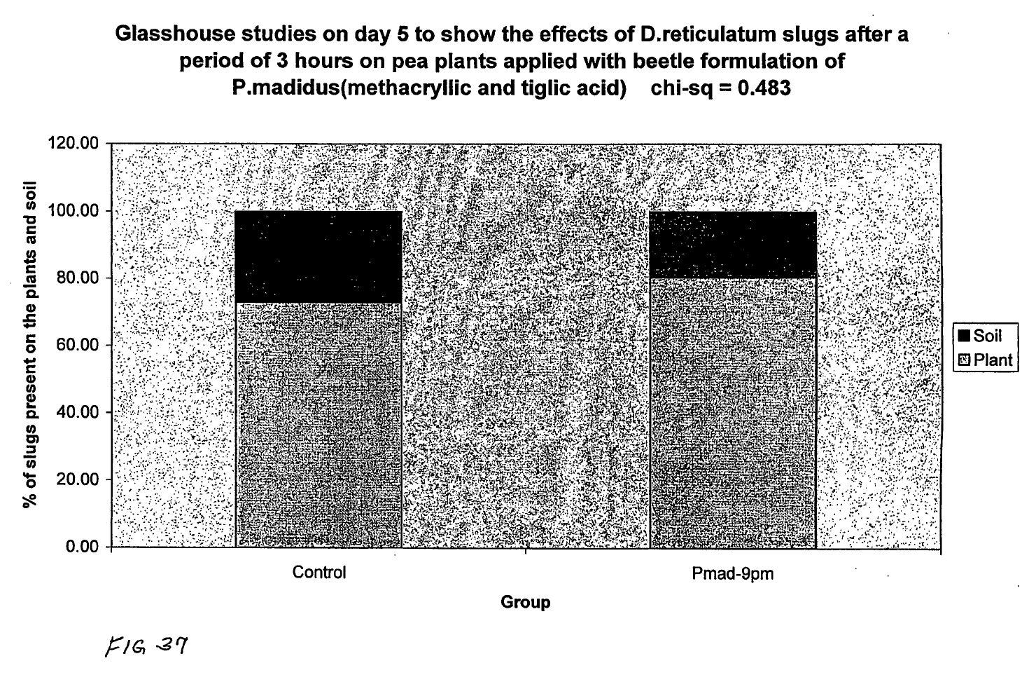

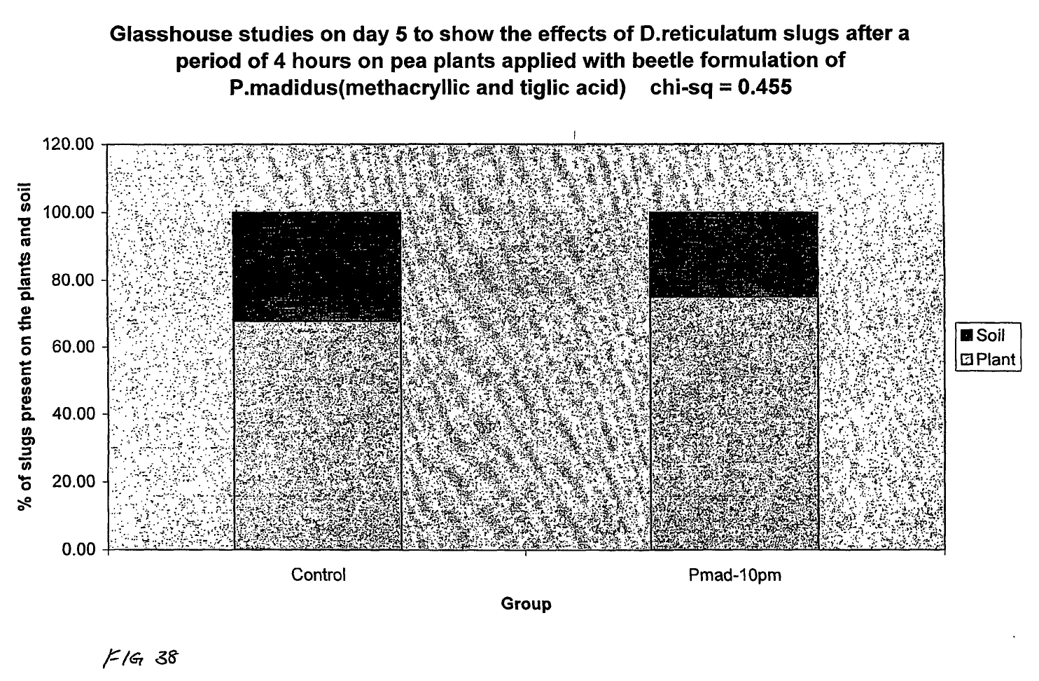

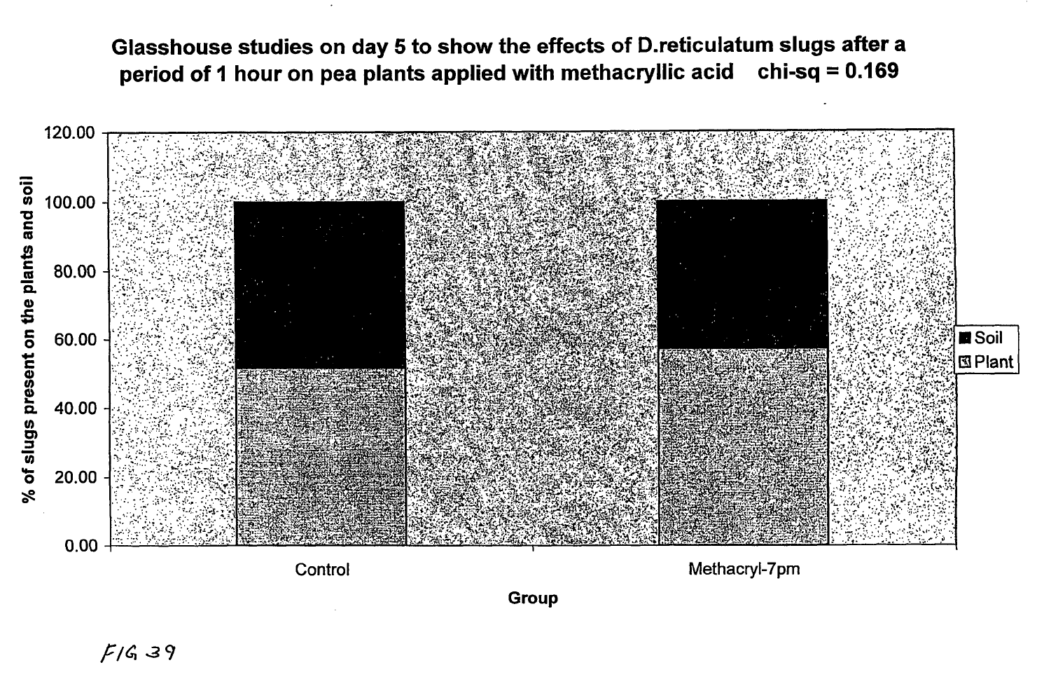

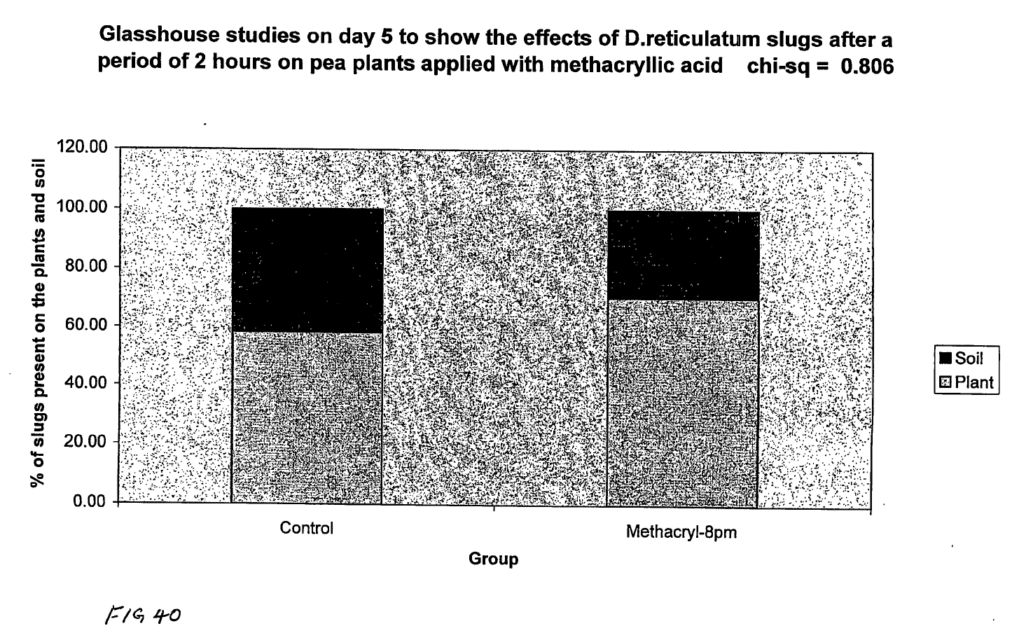

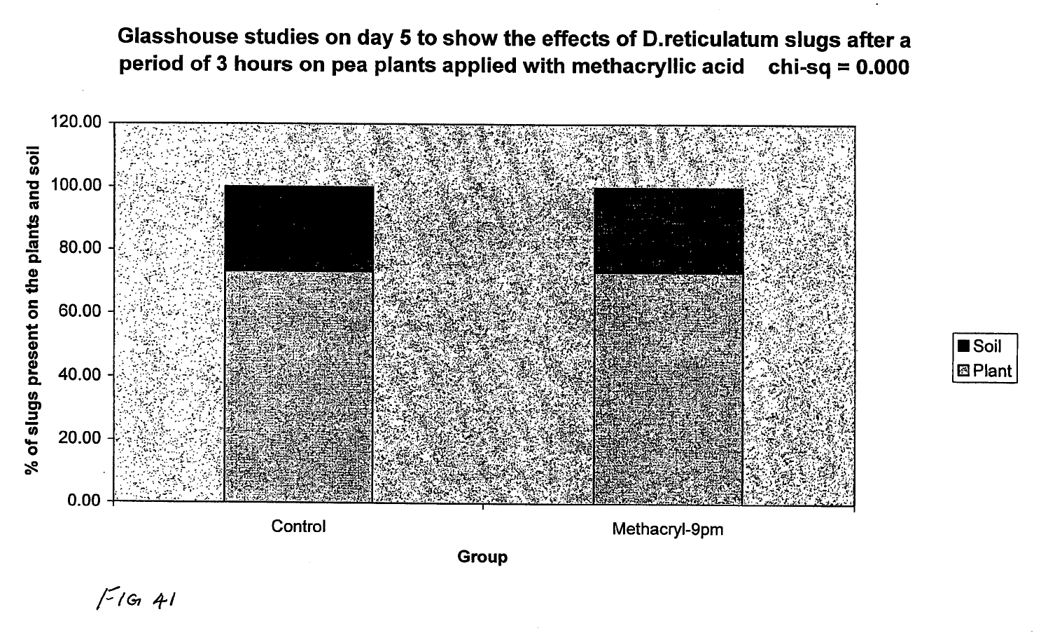

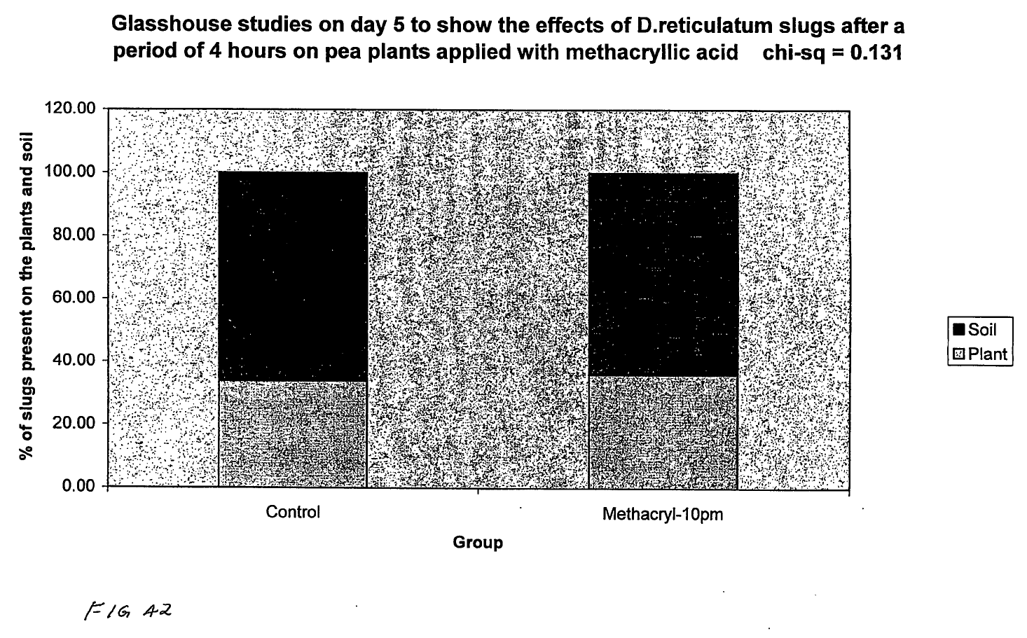

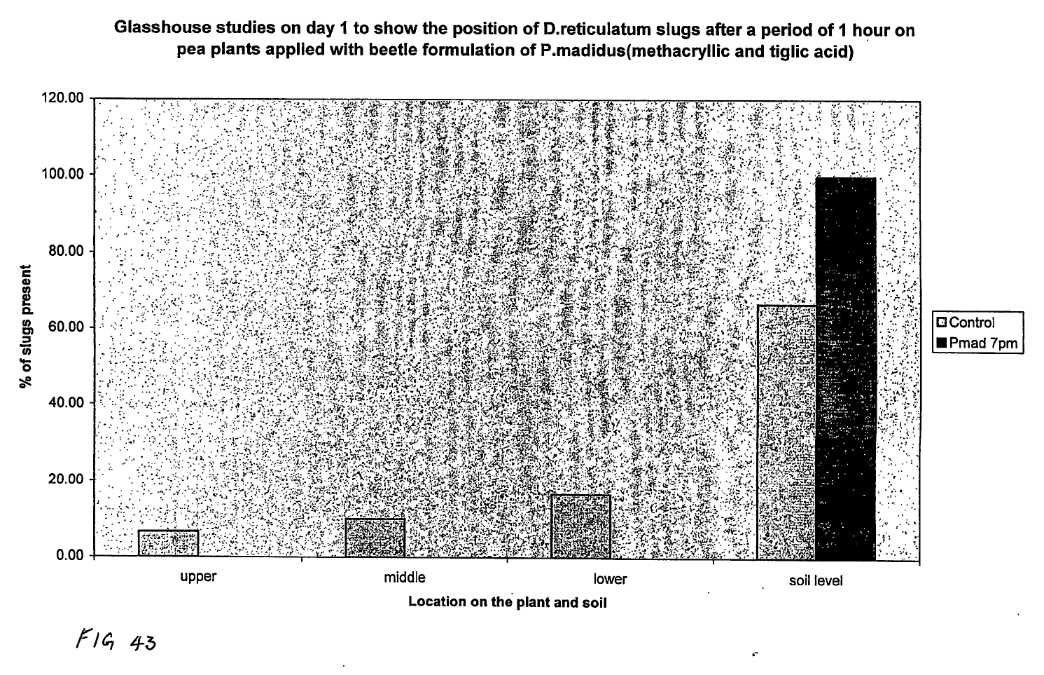

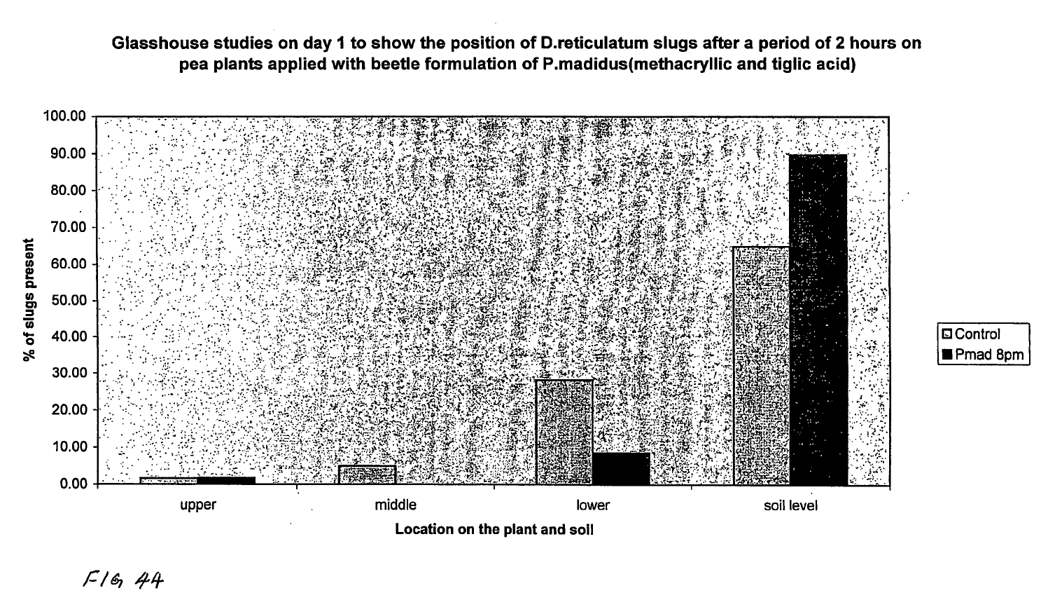

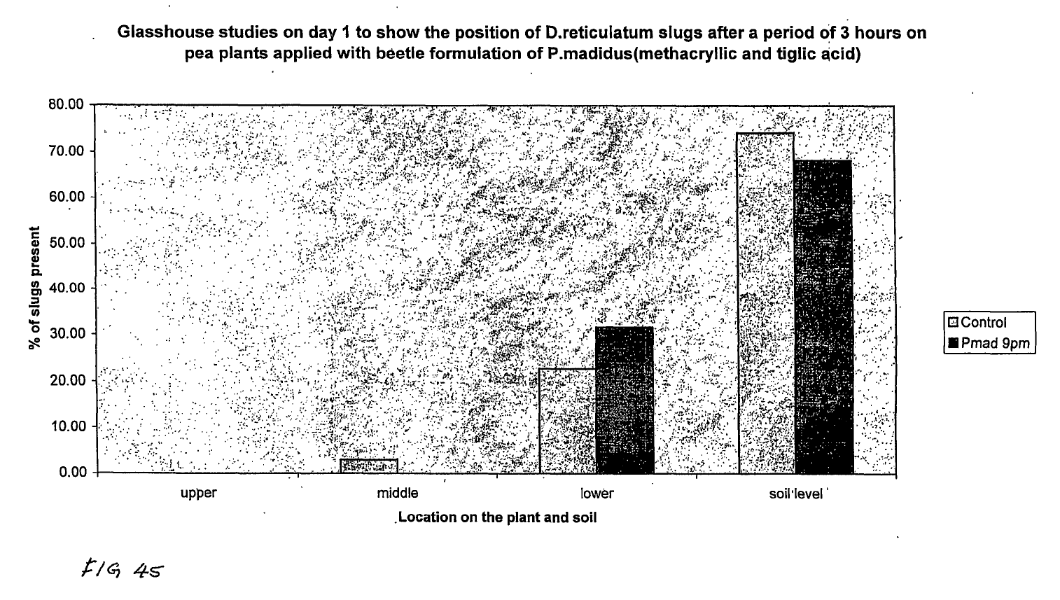

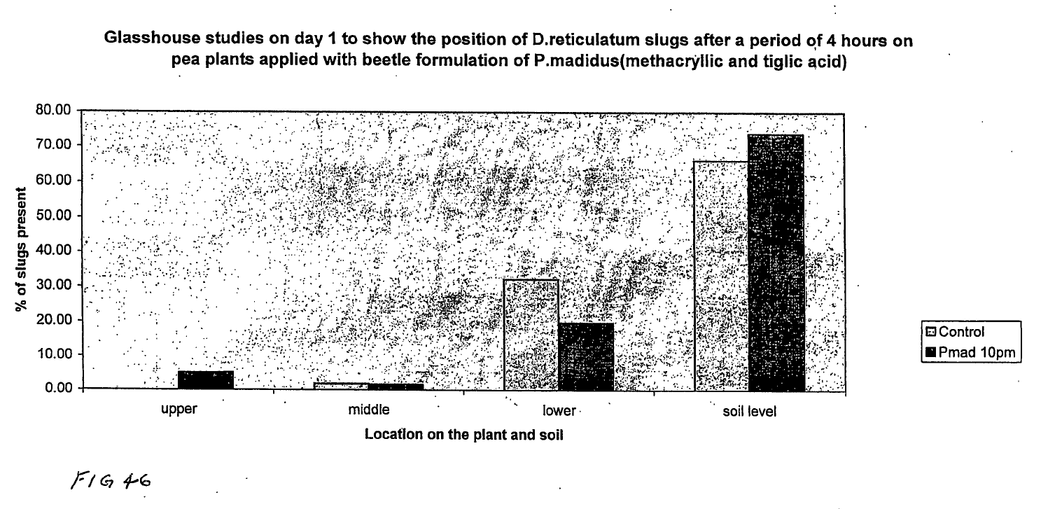

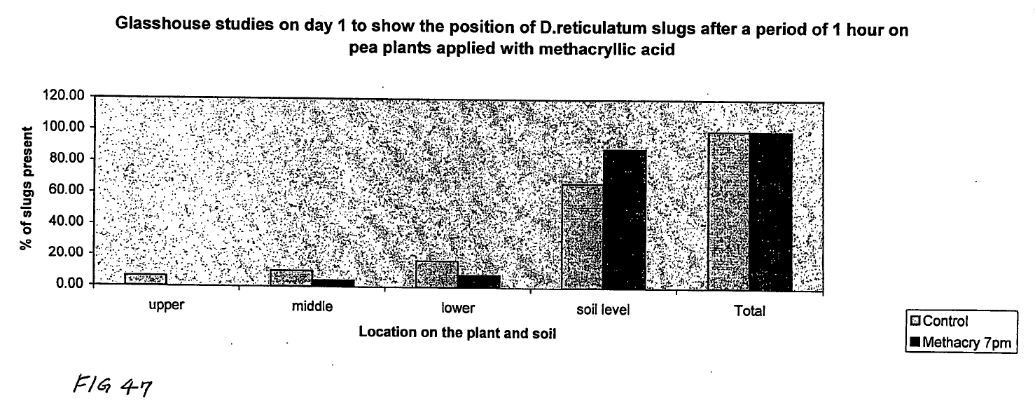

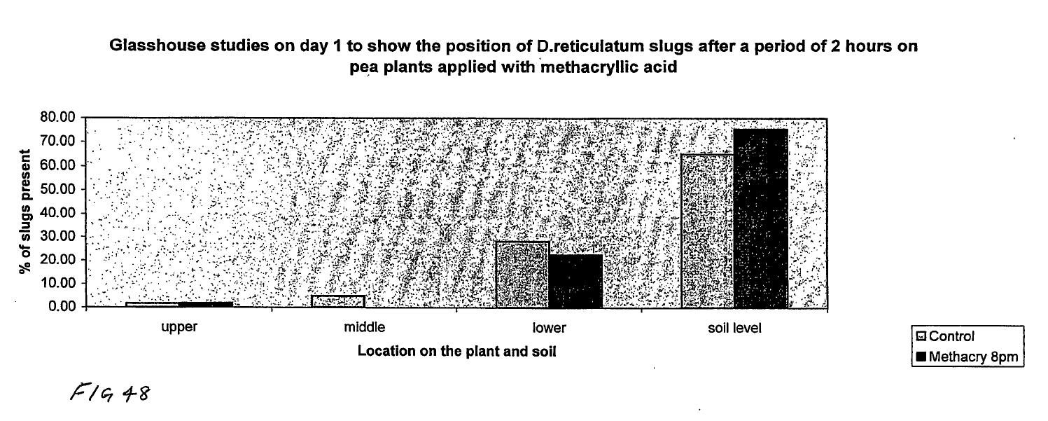

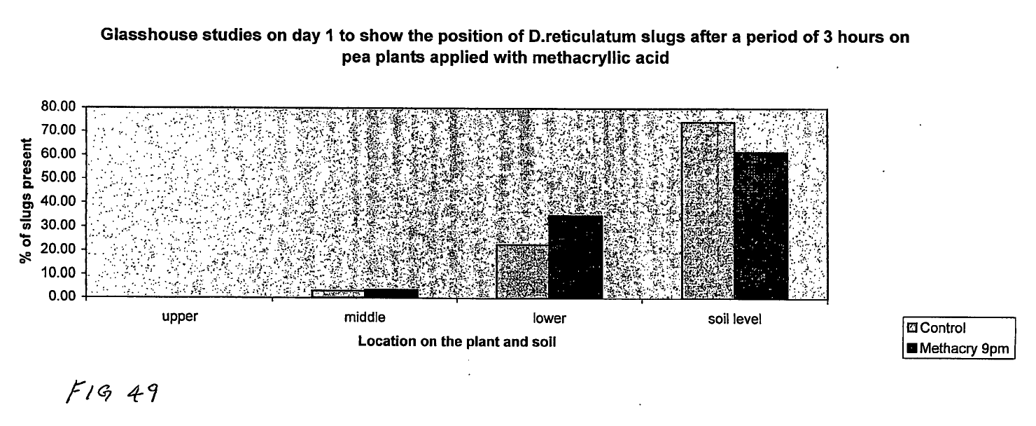

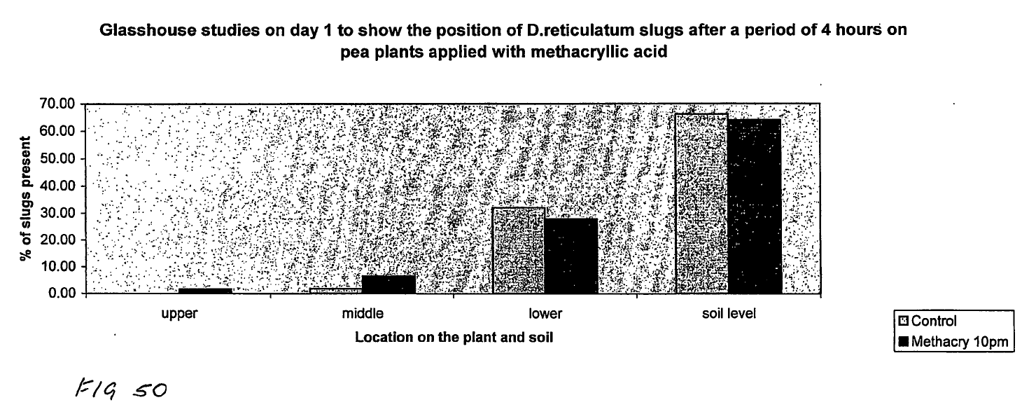

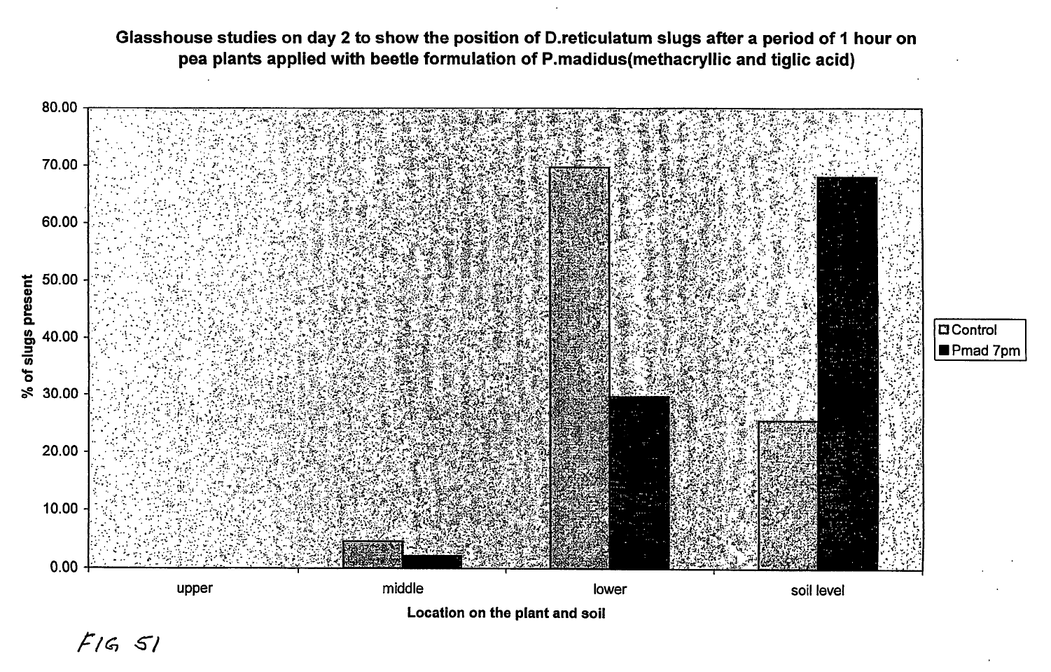

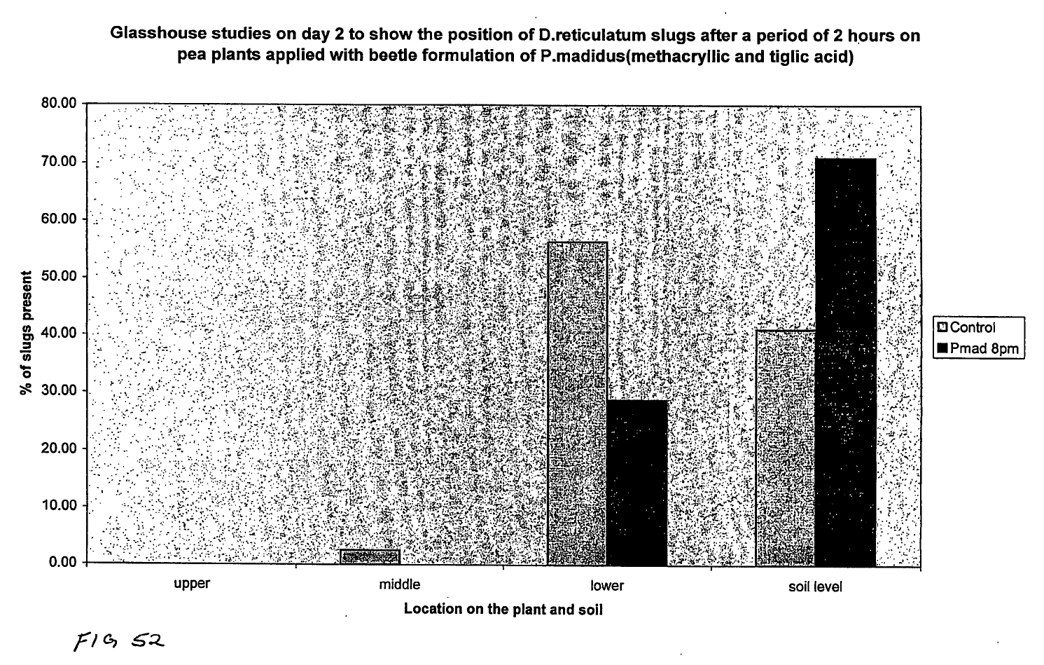

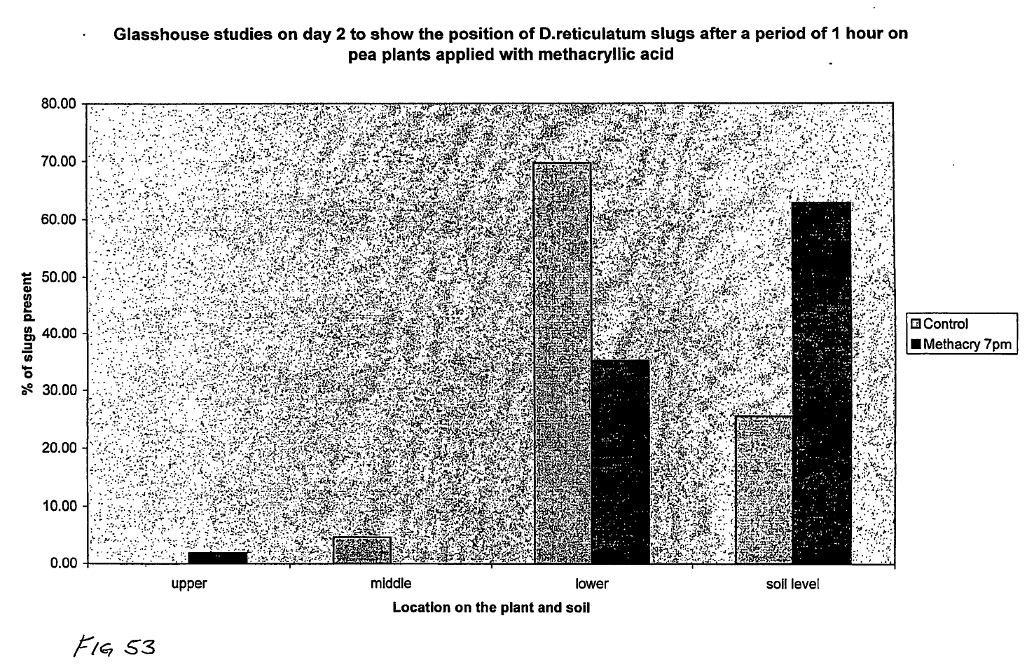

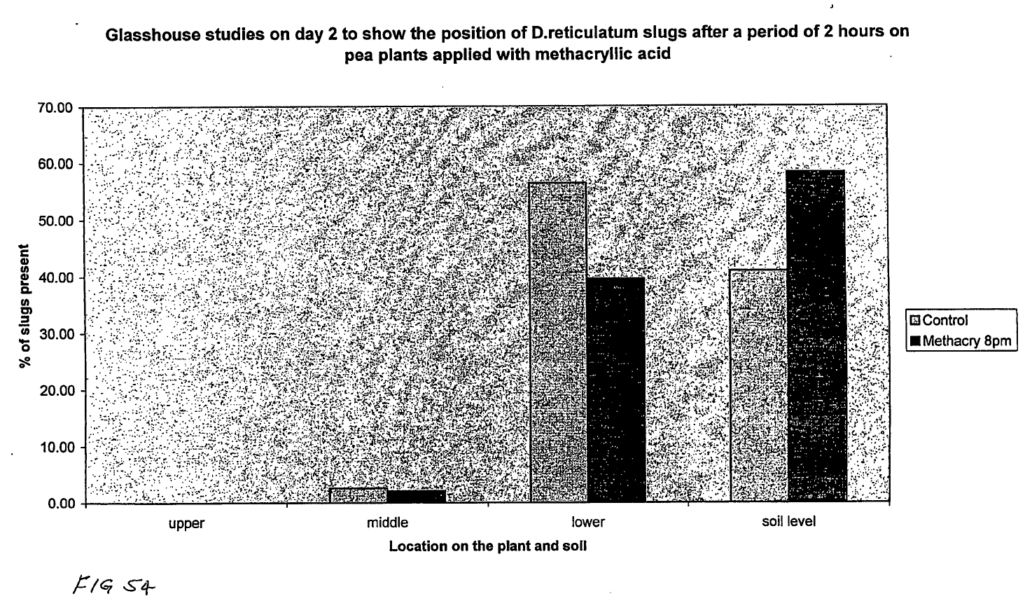

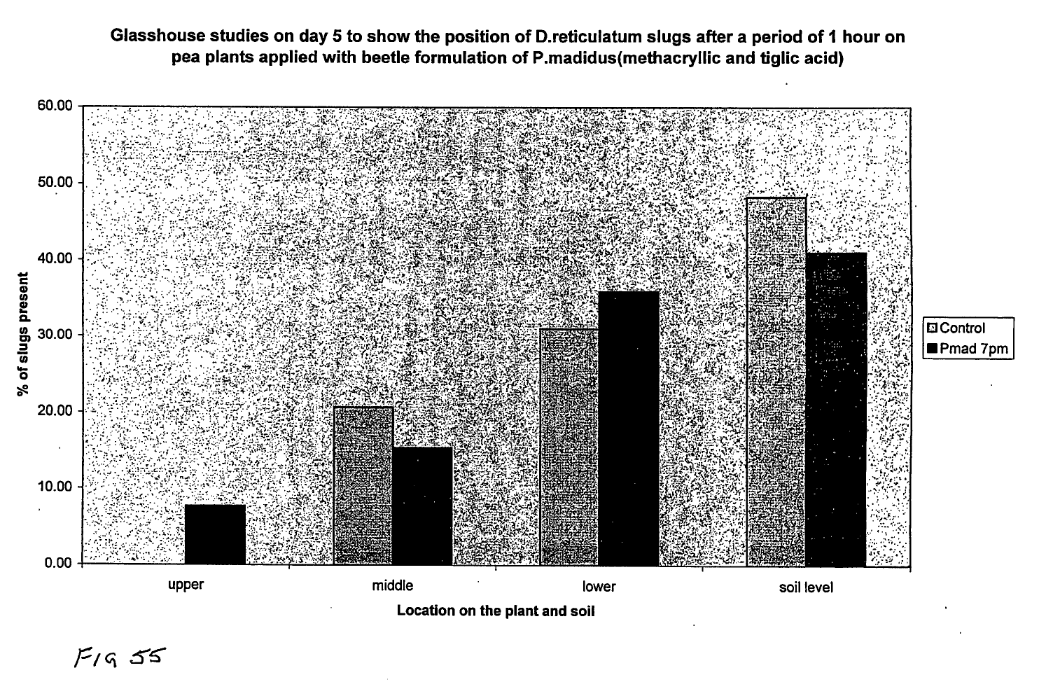

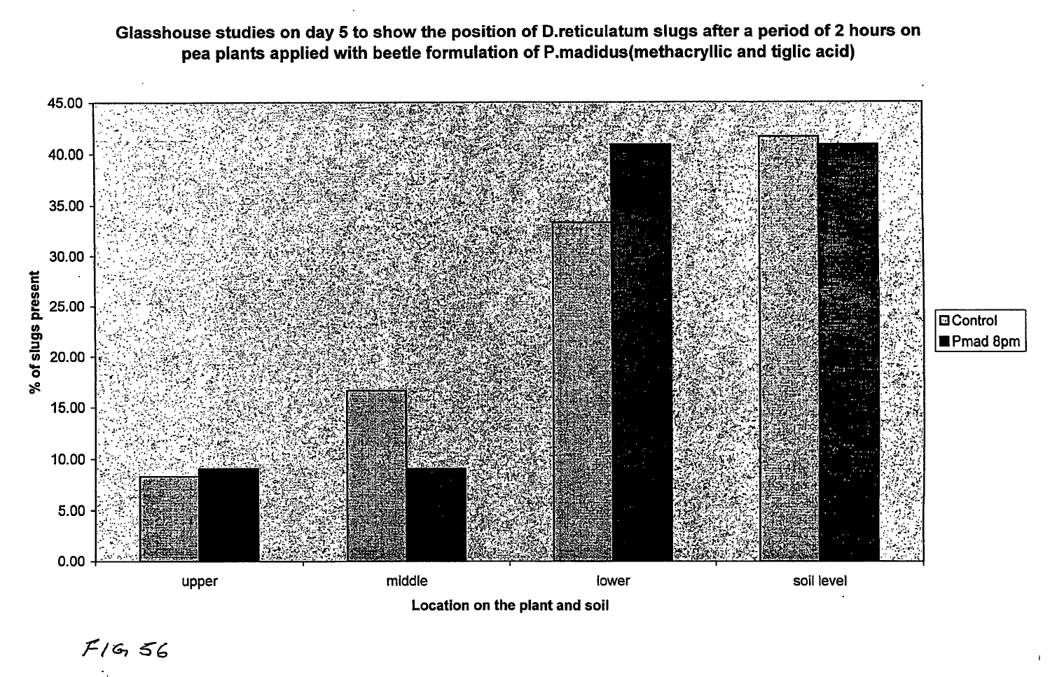

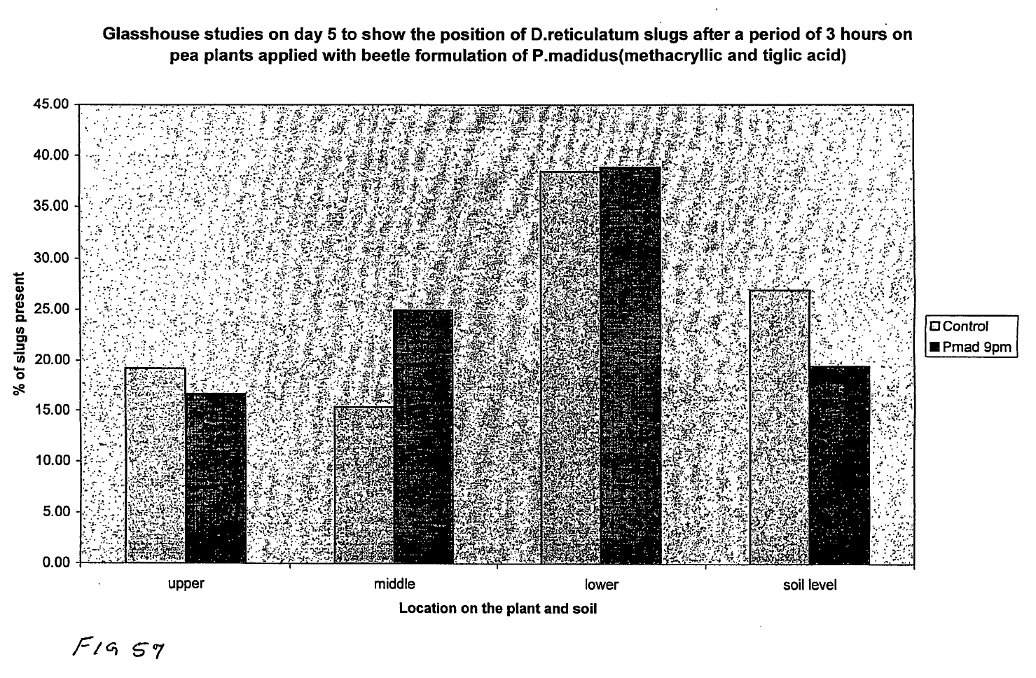

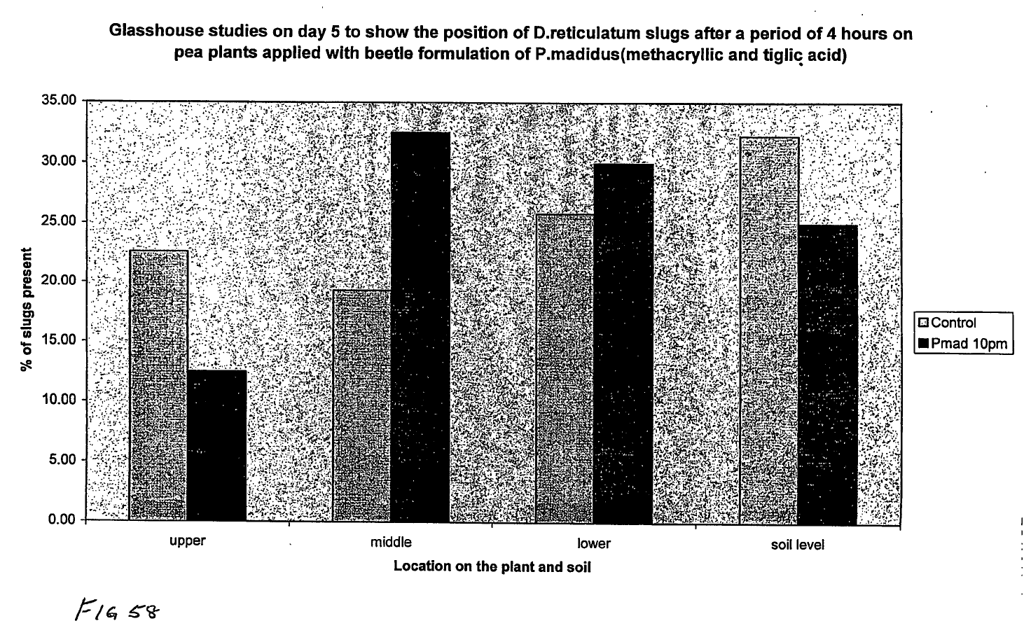

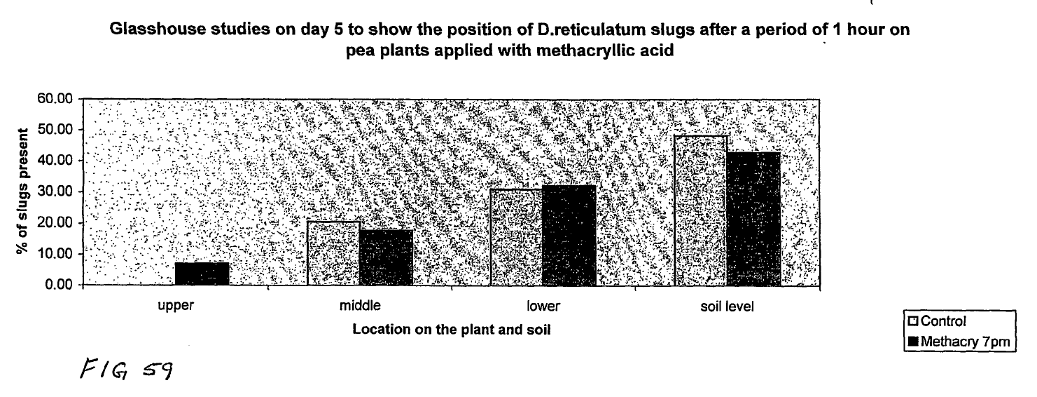

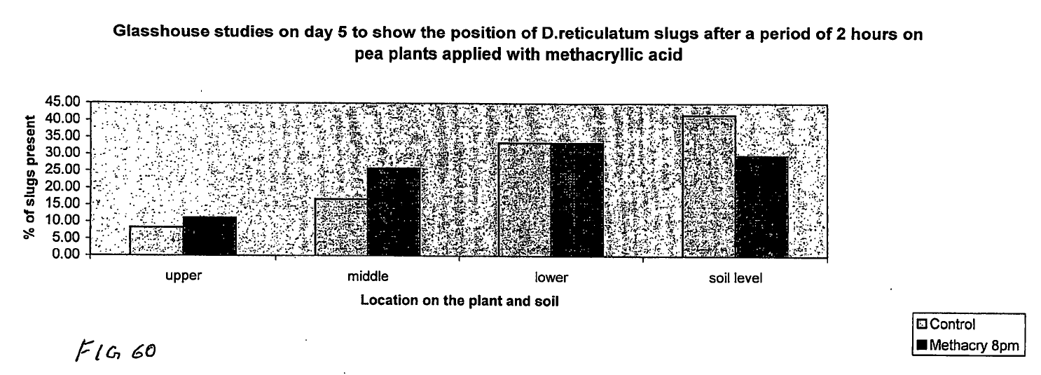

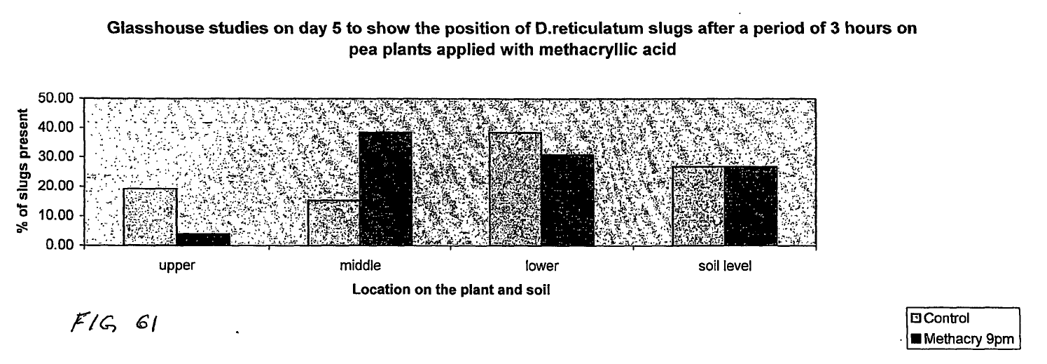

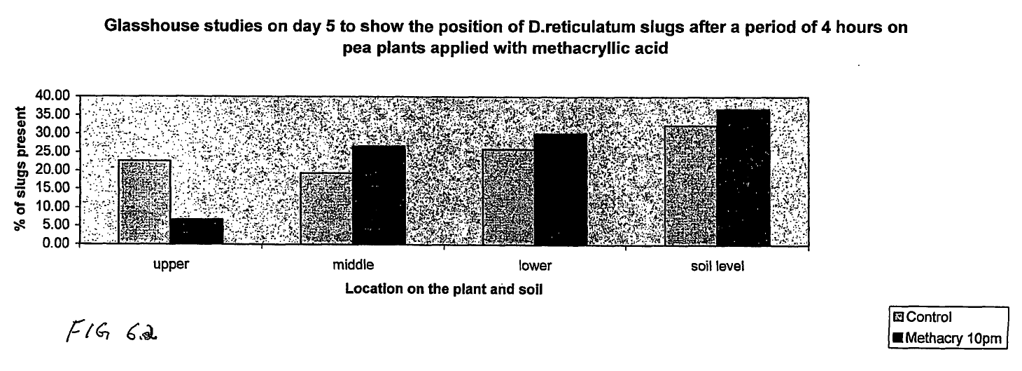

Although it has been known for quite some time that slugs are reluctant to enter areas recently colonised by ground beetles, only from an extensive series of laboratory experiments it has now become clear that slugs respond to chemical secretions from the beetles pygidial glands—situated at the tip of the abdomen (FIG. 1). Normally discharged from the glands in response to attack by beetle predators, these secretions contain a cocktail of noxious substances—usually a mixture of acids and alkanes although the balance may vary from species to species. That this defence mechanism also works to the beetles disadvantage in alerting its own potential prey was shown recently only at Cardiff University (see FIGS. 2-5) as a significant change in the behaviour of the slugs when exposed to beetle extracts. Slugs responses measured in terms of slime trails left after a period of time showed that the slugs actively avoid the treated area when the trial was conducted in 12 hours after the extract was obtained from P. melanarus beetles (FIG. 2), the trial was conducted in 24 hours after the extract was obtained in P cupreus and P madidus beetles (FIGS. 3 and 4 resp) and for trials conducted even after 48 hours, slugs avoid the treated area in H. rufipes beetles. The test also revealed that these slugs do not die during the course of this experiment. This must show that when slugs are exposed to beetle extracts there will be no side effects. Video recordings used to carry out these tests revealed a direct and rapid reaction on the part of the slugs when coming into contact with beetle extracts showing that the results are very encouraging. Reactions vary from rearing up, extreme turning behaviour and rapid contraction of the tentacles and head. In very few cases do the slugs move forward over beetle extract without one of the above reactions. In most cases observed so far, slugs turn and move away from the extract which of course is a direct evidence to show a direct negative reaction by the slugs when coming into contact with these secretions. All these reactions needless to say have been tested using many replicates, which now remains to be quantified and analysed, to show only in the PhD thesis, as a clear confirmation that these substances, in artificially prepared form can deter slugs in the manner previously shown for pygidial secretions.

### 2. THE PYGIDIAL GLAND OF THE GROUND BEETLE AND ITS UNIQUE FACILITIES TO DETER SLUGS

The experiment to show the pygidial gland was carried out under the skillful supervision of Dr. Brian Staddon, a former member of staff in the Department of Bioscience at Cardiff University, who had studied other insect glands before. To begin with, the live specimen was placed in a freezer for approximately 10 minutes when it stopped moving and transferred to a glass petri dish containing saline solution (1 gNacl/100 ml water). Next the beetle was severed in the thoracic region with a fine knife normally used for dissecting small specimens and the dorsal shield which is also referred to as fused elytra or wing cases was lifted back in order to severe the abdomen about half-way. By lateral incisions through the stemites, the posterior-tergites was isolated under a stereo microscope and showed glands open along anterior margin of posterior most visible tergal piece in P. melanarius. Under frequent changes of saline and using fine scissors and forceps, the gut, malpighian tubules, reproductive materials and other tissues were carefully removed to show the pygidial glands (FIG. 1) for that beetle.

To obtain secretion for analysis, initially the beetle was cooled to approximately 10° C. when it was observed to be sluggish. This movement was necessary in order to prevent any premature discharge, before it is milked. Next the beetle was seen to move very fast, when it was allowed to warm at room temperature. A standard procedure, commonly used to show the volatiles from the pygidial glands was used to milk the beetle. To bring the beetle under control, it was easily held by one front leg with very fine foreceps normally used by insect taxonomists to observe tiny specimens. At once the beetle raised the posterior most section of the abdomen, to eject what is believed to be a defensive secretion from the pygidial gland when come under attack, and continued to eject vigourously until it was set free. A specimen made of glass and not the normal filter paper was used to transfer these secretions, as glass would be more safe to keep the test compounds free from contamination. The dilated end of approximately 6″ glass rod was held near the beetle to catch the secretions as it was discharged and analysed using the most recent technique in Gas chromatography called the Mass spectrometry, which is used only for the identification of test compounds after passing through the Gas chromatography and its description will be relevant to show only in the PhD thesis. However, there was a mixture of methacryllic and crotonic acid around P. melanarus, whereas it was tiglic acid with methacryllic acid near P. madidus, but in P. cupreus test compound there was a large amount of acetic acid released with crotonic acid and formic acid was the only compound found in H. rufipes. Even the odour from these acids were easily recognised when the beetle was milked. A number of alkanes and ketones were also present in these samples but only as additives and therefore not used in the current study.

The important chemicals have since been obtained from commercial sources and tested to show its effect on deterring slugs from feeding on to growing plants and its effect on deterring slugs from climbing on to growing plants. The most suitable place to carry out this test is of course at Talybont which has all the glasshouse facilities to grow peas and do these tests locally and is also within a short walking distance from Cardiff University. Moreover, this site is also exclusive to Cardiff University to do fundamental research for the development of new chemicals in plant protection.

2.1 An Account of the Potential Chemicals Released by the Pygidial Glands

Only chemical companies with potential to develop these chemicals into a new slug deterrent were included under this study. Methacryllic acid for example was found in Merck, Sharp & Dohme which also has excellent lab facilities to assess the suitability of new compounds for commercial development. Next, Fisher Scientific UK Limited, a subsidiary of Fisher Scientific International Inc, who also serve customers in chemical markets, sold Crotonic acid, Acetic acid, and Formic acid to encourage this work. The demands for Tiglic acid alone was met by Sigma-Aldrich which is also a global supplier of fine chemicals for industrial markets. A physical description of the compound show, that these chemicals are also water soluble and can be mixed with distilled water, which is clearly free from all impurities that otherwise exists in ordinary water for normal use. The appearance, including the color and physical state (solid, liquid or gas) of the chemical at room temperature (20-25° C.) is reported here. If the compound can be detected by the olfactory sense, the odour is noted. For values which cannot be measured simply because the data has not been reproduced, it must be noted as unavailable.

2.1.1 Methacrylic Acid

| Physical State | Clear liquid |
|---|---|
| Color | APHA: 20 max (A scale which indicates |
| | the basic state of colour) |
| Odor | sharp odor |
| pH | Not available |
| Vapour Pressure | 0.8 mbar @ 20 deg C. |
| Viscosity | 1.4 mPas 20 deg C. |
| Boiling Point | 63 deg C. @ 760.00 mm Hg |
| Freezing/Melting point | 16 deg C. |
| Autoignition Temperature | 365 deg C. (689.00 deg F.) |
| Flash Point | 76 deg C. (168.80 deg F.) |
| Explosion Limits, lower | .08 vol % |
| Explosion Limits, upper | .02 vol % |
| Decomposition Temperature | |
| Solubility in water | 9.7 g/100 ml (20° C.) |
| Specific Gravity/Density | 1.0150 g/cm3 |
| Molecular formula | C4H6O2 |
| Molecular Weight | 86.09 |

2.1.2 Crotonic Acid

| Physical State | Flakes |
|---|---|
| Appearance | white - light yellow |
| Odor | pungent odor |
| pH | ca.3 (10 g/l aq. sol.) |
| Vapour Pressure | 0.25 mbar @ 20 deg C. |
| Viscosity | Not available. |
| Boiling Point | 185-199 deg C. @ 760.00 mm Hg |
| Freezing/Melting point | 70-73 deg C. |
| Autoignition Temperature | 490 deg C. (914.00 deg F.) |
| Flash Point | 88 deg C. (190.40 deg F.) |
| Explosion Limits, lower | Not available |
| Explosion Limits, upper | Not available |
| Decomposition Temperature | 210 deg C. |
| Solubility in water | 94 g/l in water (25° C.) |
| Specific Gravity/Density | |
| Molecular formula | C4H6O2 |
| Molecular Weight | 86.09 |

2.1.3 Acetic Acid

| Physical State | Clear liquid |
|---|---|
| Appearance | APHA: 10 max |
| Odor | pungent odor |
| pH | Not available |
| Vapour Pressure | 15 mm Hg @ 20 deg C. |
| Viscosity | 1.53 mPas 25 deg C. |
| Boiling Point | 117-118 deg C. @ 760.00 mm Hg |
| Freezing/Melting point | 16-16.5 deg C. |
| Autoignition Temperature | 427 deg C. (800.60 deg F.) |
| Flash Point | 40 deg C. (104.00 deg F.) |
| Explosion Limits, lower | 4.00 vol % |
| Explosion Limits, upper | 17.00 vol % |
| Decomposition Temperature | 210 deg C. |
| Solubility in water | miscible with water |
| Specific Gravity/Density | 1.0490 g/cm3 |
| Molecular formula | CH3CO2H |
| Molecular Weight | 60.04 |

2.1.4 Tiglic Acid

| Physical State | Powder and chunks |
|---|---|
| Appearance | white - beige |
| Odor | Not available (not distinguished) |
| pH | Not available |
| Vapour Pressure | Not available |
| Viscosity | Not available |
| Boiling Point | 198.4 deg C. @ 760.00 mm Hg |
| Freezing/Melting point | 61.00-65.00 deg C. |
| Autoignition Temperature | Not available |
| Flash Point | Not available |
| Explosion Limits, lower | Not available |
| Explosion Limits, upper | Not available |
| Decomposition Temperature | |
| Solubility in water | soluble in hot water and sparingly |
| | soluble in cold water |
| Specific Gravity/Density | 9690 g/cm3 |
| Molecular formula | C5H8O2 |
| Molecular Weight | 100.12 |

2.1.5 Formic Acid

| Physical State | Clear liquid |
|---|---|
| Appearance | colourless |
| Odor | pungent odor |
| pH | Not available |
| Vapour Pressure | 44 mbar @ 20° C. |
| Viscosity | 1.47 mPas 20 deg C. |
| Boiling Point | 101 deg C. @ 760.00 mm Hg |
| Freezing/Melting point | 8 deg C. |
| Autoignition Temperature | 520 deg C. (968.00 deg F.) |
| Flash Point | 69 deg C. (156.20 deg F.) |
| Explosion Limits, lower | 14.00 vol % |
| Explosion Limits, upper | 33.00 vol % |
| Decomposition Temperature | |
| Solubility in water | Miscible |
| Specific Gravity/Density | 1.2200/cm3 |
| Molecular formula | HCO2H |
| Molecular Weight | 46.02 |

2.1.6 Applications and Origin

These are the common uses of the five organic acids. Substances as ubiquitous as formic acid and acetic acid are used throughout industry and laboratories for many diverse functions.

Formic Acid:

Pesticides
pharmacological
Tanning (leather)
Rubber curing
Starting point raw material
   Acetic Acid
Artificial textile manufacture
pH adjustment
Demineralisation of water
Preserving
Flavouring
Solvent
Pharmacological
Raw material starting point
   Methacrylic Acid
monomer for various methacrylic polymers
   Crotonic Acid
Pharmacological
Co-polymer for food packaging films
   Tiglic Acid
Pharmacological
Alternative medicines
Perfumes
   Source

Formic acid naturally occurs in carrots, soybean roots, carob yarrow, aloe, Levant berries, bearberries, wormwood, ylang-ylang, celandine, jimsonweed, water mint, apples, tomatoes, bay leaves, common juniper, ginkgo, scented boronia, corn mint; European pennyroyal, and bananas.

Source

Acetic acid occurs naturally in many plant species including Merrill flowers, cacao seeds, celery, blackwood, blueberry juice, pineapples, licorice roots, grapes, onion bulbs, oats, horse chestnuts, coriander, ginseng, hotpeppers, linseed, ambrette, and chocolate vines.

### 3. INTERACTIONS BY THESE CHEMICALS WITH DEROCERAS RETICULATUM SLUGS

3.1 Laboratory Studies to Show This Tests

Next, using the results obtained from Mass spectrometry to make up the test solutions with these organic acids, the behaviour of the slugs in the presence of beetle odours was now investigated. Initially this test was carried out inside the laboratory in the manner previously shown for pygidial secretions using a control and test sector to show the slug's choice overnight within a petri dish. The proportion of the total area of the petri dish covered by the slug trails during the 24 hour period (n=10 replicates) showed that the slugs actively avoid the treated area in P. melanarius, P. madidus, P. cupreus and H. rufipes beetles. The results showed there is a significant change in the behaviour of the slugs and most important it was discovered that the slugs do not die when exposed to beetle odour manufactured from commercial sources. In a separate test the potential of each chemical on its own was also demonstrated simultaneously to show this avoidance behaviour. However the results of all these tests still remains to be analysed and will appear in the PhD thesis only after using a computer software for image analysis.

3.2 The Potential of These Chemicals Under Semi Field Conditions on Growing Pea Plants

3.2.1 A Glasshouse Study Showing its Effect to Deter Slugs from Feeding Onto Growing Plants

Once this breakthrough was made from inside Cardiff University, the next stage was to reflect these experiments for field studies where tests would show that it is safe to use these chemicals to stop slugs from feeding and climbing onto growing pea plants. A suitable experimental design had to be substituted for this glasshouse study, based on the principles to show avoidance behaviour. This was also remarkably achieved on a five point scale to record slug behaviour, under a simple experimental procedure which lasted for only five days, to conclude this semi-field trial just by using the existing facilities alone at Talybont. Addis Housewares Ltd who manufactured their items for supermarket sale, provided plastic bowls in different colours to suit a random style experiment to show this current field study inside the glasshouse. Whifford Plastics Ltd produced fluon, a test chemical which had been used before to stop slugs from escaping the planned experiment in Cardiff University, was sold in litres sufficient to cover the sides of these plastic bowls by using only a simple paint brush. F. A Smith a soil merchant supplying for Cardiff University Horticultural services at Talybont, produced John Innes Potting compost No 2 commonly used in a nursery for growing peas, ideally because the sterilised soil with peat and and grit added has a base fertiliser for quick germination. Next, Lyndon Tuck who was employed as a Cardiff University technician to do horticultural work at Talybont and had previous experience in growing peas therefore supplied these plants which was just under 19 days old inside ¼ trays, in order to carry out this chemical treatment. ‘Feltham First’ seeds which of course is widely used by the majority of the growers in the UK to grow their peas because of the good quality of these peas, was supplied by ‘Moles’ a seed company in Essex who also produce and sell seeds on a regular basis to supermarkets. To keep the peas nice and damp and the slugs happy, the multipurpose peat based compost from the local B&Q store was adequate to support the trays of peas inside the plastic bowls which was ⅔ filled with this moist peat and the tray positioned so that the rim is flush with the surface of the peat. All the slugs used in this experiment were collected from the fields around Talybont, where they were actively seen to be searching for food lurking under the plants during the early hours of the morning at sunrise and pre-starved for a further 24 hours at 15° C., 80% RH, 12 hour light: dark regime, prior to testing inside the glasshouse. These were also the same species of slugs causing contamination during the routine operation in vining peas and has a latin name Deroceras reticulatum, already well known for its physical damage to other crops under use in the UK. Deroceras reticulatum, otherwise referred to as ‘grey field slug’ can also be easily identified from its external features because of its distinct outward appearance with a somewhat light grey background and covered longitudinally from the body in a clearly visible pattern, which is why it is named as reticulatum in latin language. When testing new chemicals as for example in peas, large volumetric flasks were appropriate because the test solutions were made in litres and Hozelock Ltd who specialised in gardening equipment for local Home based stores around the country, supplied the big lavish sprayers necessary to test these chemicals on the growing plants. Also safety must be observed by taking precautions to wear head masks and disposable hand gloves during spraying when setting up this simple experiment. The spraying of these chemicals must also be completed within a reasonable time to show that the outcome of this experiment is a set of results which are not biased. In that respect it would be wise to use a separate glasshouse when spraying each chemical, in order to avoid losing time between such treatments and care must be taken not to drench the plants by simply using the facilities available on these sprayers to produce only a fine mist necessary to protect the plants from Deroceras reticulatum slugs. Once the plant was covered with what was believed to be a friendly solution to deter these slugs even from a small distance, it was estimated that ten slugs can be allowed into one bowl to match the eight plants, the extra two slugs to compensate for any accident that may incur when these slugs are introduced into the bowls to start this random style experiment. Simply clear tap water was used to compete with these test solutions from P. melanarius, P. madidus, P. cupreus and H. rufipes beetles, with forty 315×285×220 mm bowls in five different colours ranging from forest green, blue, metallic, biscuit and yellow to match these treatments. For instance forest green was always used as controls to test the samples from tap water while blue (P. melanarius), metallic (P. madidus), biscuit (P. cupreus) and yellow (H. rufipes) were regular features strictly to show only the test solutions in brackets and its position in order to avoid any mix up when this experiment is in progress. The number of replicates had to be squeezed to eight because only forty such bowls can be accommodated inside the glasshouse except giving room to manoeuvre when required to check the temperature, the level of humidity and besides keep the peat and the floor moist. The percentage of leaves removed and chewed by the slugs were recorded each day to show this slug damage based on a five point scale:
1. the number of undamaged leaves
2. the number of leaves with damage up to 25% of the leaf removed
3. the number of leaves with 25%-50% damage
4. number of leaves with 50%-75% damage
5. number of leaves with >75% damage
   and numbers 1-5 were added to show the total number of damaged and undamaged leaves found in each replicate for the recording day. This was an experiment carried out to show only the feeding damage by the slugs. Regular checks were also made to see whether there was a colour transformation on the leaves as a result of this experiment. Only if it was considered to be serious, the damage was noted.

3.2.2 And its Effect to Deter Slugs from Climbing Onto Growing Pea Plants

In a separate experiment, the climbing habits of these slugs were also observed to show direct evidence of chemical avoidance to support this study. This was easily done from three different points on the plants, supposing we say they are upper, middle and lower level to describe these positions which must also include the soil inside the bowl to explain the avoidance behaviour if the slugs are not found any where near these plants. Once the slugs were distributed in this manner the rest was just statistics. The position of the slugs on the plant itself is very important, because if the result shows that these tiny molluscs can be stopped from migrating to the inside of the plants then one can assume that beetle odours have the potential to develop into a new slug deterrent. This can be effectively achieved once this test is proved to be positive and ideally a short term effect say for instance between 2-3 hours just before harvest will be sufficient to provide the growers with the necessary instruments to clear the problems facing the vining peas from Deroceras reticulatum slugs. Therefore recordings were made well after 7 pm when it was dark outside to show this effect.

The potential of each test compound was also tested out separately to explain the feeding and hence the climbing habits of these small creatures.

### 4. RESULTS

4.1 Progress Made to Show the Effects of Beetle Odours Against the Feeding Damage by Deroceras reticulatum Slugs on Peas

The outcome of the experiment for feeding damage caused by Deroceras reticulatum slugs on growing pea plants clearly show, that beetle odours have the potential to control the existing slug populations even in a field situation. This was indeed achieved on the 2^{nd} day of this test, when damage was effectively reduced by simply adding methacryllic acid to any test or even methacryllic acid on its own to show that beetle odours can be used as an effective deterrent against slugs on growing pea plants. That is why feeding damage by Deroceras reticulatum slugs was effectively reduced in P. madidus and P. melanarius ground beetles which contained methacryllic acid in their test compounds. This control was also obvious on the 5^{th} and the final day of this test showing these results as successful. This success was also shared by H. rufipes group containing only formic acid, a deterrent already known to scare slugs stiff in laboratory studies inside Cardiff University. The control message was also obvious for the other group of beetles in this experiment. Concern for acetic and tiglic acid on the 2^{nd} day may be due to an experimental error?

4.2 And a Climbing Test by the Molluscs to Show This Improvement

However, direct evidence was required to show that these slugs can be pushed away from the plants to stop them from interfering when the viners come out to do their job, in a simple test to see where the slugs remain once the beetle odour is introduced over the plants, in the same manner as before. A period of just two hours was sufficient to keep the slugs paralysed on the soil in plants covered with P. madidus solutions and there was also a similar response indeed by methacryllic acid on the 1^{st} day of this test to show that Deroceras reticulatum slugs can be stopped from migrating to the inside of the plants once the slugs became distributed under these results. But the very good news is, the slugs were still alive after each experiment to show that beetle odours made from artificial chemicals do not have any side effects even on the 5^{th} and the final day of this test. The potential to show no side effects by these chemicals must be seen as an excellent opportunity to develop beetle odours into a new slug deterrent.

The significance of these results for both feeding and climbing have been tested under a simple chi-sq test to show that these chemicals have reached the required standard necessary to progress this work to the next stage of this study and details of both these tests can be followed from my PhD thesis under the competed analysis for the chi-sq resolution.

### 5. CONCLUSION

The current study now repeats the progress made in the laboratory to show that this can be achieved also in the fields without killing the slugs as seen before and thus leading those unfortunate growers to a new way of reducing slug contamination at harvesting. In order to continue with this work it must be taken to a stage where it is of practical value to the UK farmers where more tests would show that it is safe to use these chemicals also in the fields. Therefore this work will be of benefit td the growers only if it can be shown that these safety standards are met with as future studies to continue after the PhD, under a new proposal. It is only after this next stage the growers will be able to see the new slug deterrent as a potential source against slug contamination during harvest in vining peas. However, a proposal will be drawn up soon at Cardiff University to show how this work can be carried out in several stages to show the improvement necessary to progress this work for the growers. Chemical companies will also receive the new slug deterrent as a potential source to stop and prevent slugs from entering into other crops currently for use in the UK.

1. A method of repelling or deterring slugs comprising the steps of:
obtaining naturally occurring secretions from a ground beetle; and
applying the beetle secretions to an application surface.

2. The method of claim 1, wherein the application surface comprises at least a portion of a plant.

3. The method of claim 2, wherein the plant is a pea plant.

4. The method of claim 1, wherein the beetle secretions include at least one acid selected from the group consisting of methacrylic acid, tiglic acid, crotonic acid, formic acid and acetic acid.

5. A slug repellent comprising:
water; and
at least one acid selected from the group consisting of methacrylic acid, tiglic acid, crotonic acid, formic acid and acetic acid.

6. The slug repellent of claim 5, wherein said at least one acid comprises methacrylic acid

7. The slug repellent of claim 6, wherein said at least one acid further comprises tiglic acid.

8. The slug repellent of claim 6 wherein said at least one acid further comprises crotonic acid.

9. The slug repellent of claim 5, wherein said at least one acid comprises formic acid.

10. The slug repellent of claim 5, wherein said at least one acid comprises acetic acid.

11. The slug repellent of claim 10, wherein said at least one acid further comprises crotonic acid.

12. The slug repellent of claim 5, wherein said at least one acid comprises tiglic acid.

13. The use of a composition to deter slugs, the composition comprising at least one acid selected from the group consisting of methacrylic acid, tiglic acid, crotonic acid, formic acid and acetic acid.

14. The use as claimed in claim 13, wherein the composition is used to deter slugs in plants.

15. The use as claimed in claim 14, wherein the composition is used to deter slugs in pea plants.
